(19) United States
(12) Patent Application Publication
(10) Pub. No.: US 2016/0224447 A1
(43) Pub. Date: Aug. 4, 2016

(54) RELIABILITY VERIFICATION APPARATUS AND STORAGE SYSTEM

(71) Applicant: FUJITSU LIMITED, Kawasaki-shi (JP)

(72) Inventor: Takanori NAKAO, Kawasaki (JP)

(73) Assignee: FUJITSU LIMITED, Kawasaki-shi (JP)

(21) Appl. No.: 14/970,951

(22) Filed: Dec. 16, 2015

(30) Foreign Application Priority Data
Feb. 2, 2015 (JP) 2015-018371

(51) Int. Cl. G06F 11/20; G06F 11/34; G06F 11/30

(52) U.S. Cl. CPC G06F 11/2094; G06F 11/3034; G06F 11/3409; G06F 2201/805

(57) ABSTRACT

A reliability verification apparatus includes a memory device and a processor. A transition model of a plurality of nodes is stored in the memory device. Each node indicates presence or absence of a failure of each of storage devices included in a storage system. The processor is configured to select a plurality of first nodes from the plurality of nodes, and extract sub-models for the respective first nodes. The sub-models indicate state transitions occurring due to a failure of any of the storage devices from the respective first nodes. The processor is configured to modify the transition model such that two or more first nodes are integrated into one first node of the two or more first nodes when the sub-models extracted for the two or more first nodes satisfy a predetermined condition, and calculate reliability information regarding reliability of the storage system on basis of the modified transition model.

### CROSS-REFERENCE TO RELATED APPLICATION

This application is based upon and claims the benefit of priority of the prior Japanese Patent Application No. 2015-018371, filed on Feb. 2, 2015, the entire contents of which are incorporated herein by reference.

### FIELD

The embodiment discussed herein is related to a reliability verification apparatus and a storage system.

### BACKGROUND

In a storage system including a plurality of redundant storage devices, verification (evaluation) of the reliability of the storage system (the plurality of storage devices) is occasionally performed as an index for the availability of the system. The reliability to be verified is information which indicates the probability that the system operates normally after the elapse of a predetermined period of time (the probability that failure of a storage device leading to unrestorable data does not occur). For example, the reliability may be obtained by using a model which presents the failure of each storage device and a state transition to recovery from failure. A Markov model is known as such a model.

An operator who performs verification of the reliability of the storage system may calculate, as the reliability, the probability that the system operates normally, by calculating a disk failure rate in the storage system after the elapse of a predetermined period of time (for example, one year) by using the Markov model, for example.

Regarding redundant storage devices, there are known storage devices which use a maximum distance separable (MDS) code and known storage devices which use a code (hereinafter, referred to as a non-MDS code) different from the MDS code.

With an MDS code such as a Reed-Solomon (RS) code, for example, data is restorable until a specific number of disks fail, and the data becomes unrestorable when the specific number of disks fail. In an example of a storage system illustrated in FIG. 23 in which an MDS code is applied, data is restorable even though two disks fail. However, data becomes unrestorable when three disks fail, thereby leading to occurrence of data loss.

With a non-MDS code, the number of failed disks which lead unrestorable data is indefinite, and the number of failed disks which lead unrestorable data varies depending on combinations of failed disks. In an example of a storage system illustrated in FIG. 24 in which a non-MDS code is applied, there is a case where data is unrestorable due to a failure of three disks (failure of the disks A), and there is a case where data is restorable despite the failure of three disks (failure of the disks B).

Here, it is considered that a Markov model is prepared regarding a storage system in which an MDS code is applied and data becomes unrestorable when m disks fail. FIG. 25 exemplifies the Markov model, in which the number (0 to m) of disks in a failure state is individually indicated by a node, and the probability of disk failure during a certain period of time is expressed as λₙ and the probability of disk recovery during the period of time is expressed as μₙ when n disks fail.

As illustrated in FIG. 25, since the number of failed disks which lead unrestorable data is definite with an MDS code, a state transition between failure and recovery becomes one dimensional in accordance with the change in the value of the number of failed disks. In FIG. 25, the white nodes denote that data is restorable even though the specified number of disks are in a state of failure, and the shaded node denotes that data is unrestorable when the specified number of disks are in a state of failure.

On the other hand, it is considered that another Markov model is prepared regarding a storage system in which a non-MDS code is applied and the probability of recovery varies depending on combinations of the failed disks. FIG. 26 exemplifies the Markov model in which the number of disks is 3, and a probability of failure of a certain disk during a certain period of time is expressed as λ and a probability of disk recovery during thereof is expressed as μ while causing each node to have a combination so as to indicate whether or not each disk is in a failure state with respect to all of the disks. In FIG. 26, each node indicates the presence or absence of failure regarding the disks (the disks 0 to 2).

As illustrated in FIG. 26, since the number of failed disks which lead unrestorable data is indefinite with a non-MDS code, the Markov model is a model in which two nodes are connected to each other between which a state transition between failure and recovery with respect to only one disk may occur. In this case, state transitions between the nodes branch off depending on the failed disks, thereby making the model two dimensional.

In FIG. 26, O in each node indicates that the corresponding disk is in operation (not failed), and X indicates that the corresponding disk is in a failure state. The white nodes denote that data is restorable despite a combination of the failed disks indicated by the node, and the shaded nodes denote that data is unrestorable with a combination of the failed disks indicated by the node. Hereinafter, the white nodes may be referred to as restorable nodes, and the shaded nodes may be referred to as unrestorable nodes.

There is a known related technique in which isomorphs are removed by discriminating isomorphic models of a graph in the Markov model so that the number of candidates is reduced by narrowing down the candidates to non-isomorphic candidates.

Related techniques are disclosed in, for example, Japanese National Publication of International Patent Application No. 2007-529062 and Japanese National Publication of International Patent Application No. 2014-515131.

FIG. 27 is a diagram illustrating an example of comparing scales of Markov models with respect to a storage system in which an MDS code is applied and a storage system in which a non-MDS code is applied. As illustrated in FIG. 27, when the number of disks is expressed as m, the number of nodes for the system applied with the MDS code is m. In contrast, the number of nodes for the system applied with the non-MDS code becomes 2^{m}. The number of edges indicating the number of state transitions (the number of arrows in FIGS. 25 and 26) becomes 2m for the system applied with the MDS code. In contrast, the number of edges becomes 2^{m}m/2 for the system applied with the non-MDS code.

As illustrated in FIG. 27, when calculating the reliability of the redundant storage system, if a model has a significant scale as that of a storage system in which a non-MDS code is applied, an amount of computation increases, thereby leading to an increase of a computation time. Moreover, it may be difficult to perform computation depending on performance of an information processing apparatus such as a personal computer (PC) and a server, which performs the computation.

Therefore, a case using the Markov model is limited to a redundant configuration utilizing an MDS code, which allows a simple model to be established, and a redundant configuration in which a small scale model may be established despite a redundant configuration utilizing a non-MDS code.

### SUMMARY

According to an aspect of the present invention, provided is a reliability verification apparatus including a memory device and a processor. The memory device is configured to store therein a transition model indicating state transitions between a plurality of nodes. Each of the plurality of nodes indicates presence or absence of a failure of each of a plurality of redundant storage devices included in a storage system. Different nodes of the plurality of nodes indicate different combinations of presence or absence of a failure of each of the plurality of redundant storage devices. The processor is configured to select, from the plurality of nodes, a plurality of first nodes different from each other on basis of the transition model stored in the memory device. The processor is configured to extract sub-models for the respective first nodes on basis of the transition model. The sub-models indicate state transitions occurring due to a failure of any of the plurality of redundant storage devices from the respective first nodes. The processor is configured to modify the transition model such that two or more first nodes are integrated into one first node of the two or more first nodes when the sub-models extracted for the two or more first nodes satisfy a predetermined condition. The processor is configured to calculate reliability information regarding reliability of the storage system on basis of the modified transition model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a storage system according to an embodiment;

FIG. 2 is a diagram illustrating an exemplary functional configuration of a client apparatus illustrated in FIG. 1;

FIG. 3 is a diagram illustrating an example of a Markov model according to an embodiment in a graphical form;

FIG. 4 is a diagram illustrating an example of a Markov model according to an embodiment in a tabular form;

FIG. 5 is a diagram illustrating an example of extracting a child graph;

FIG. 6 is a diagram illustrating an example of determining whether child graphs are isomorphic to each other;

FIG. 7 is a diagram illustrating an example of setting serial numbers to nodes;

FIG. 8 is a diagram illustrating an example of a Markov model illustrated in FIG. 7 in a tabular form;

FIG. 9 is a diagram illustrating an example of deleting an isomorphic child graph;

FIG. 10 is a diagram illustrating an example in which processing illustrated in FIG. 9 is performed on a matrix;

FIG. 11 is a diagram illustrating an example of deleting an isomorphic child graph;

FIG. 12 is a diagram illustrating an example in which processing illustrated in FIG. 11 is performed on a matrix;

FIG. 13 is a diagram illustrating an example of deleting an isomorphic child graph;

FIG. 14 is a diagram illustrating an example in which processing illustrated in FIG. 13 is performed on a matrix;

FIG. 15 is a diagram illustrating an example of a compression result of a Markov model illustrated in FIG. 7;

FIG. 16 is a diagram illustrating an example of a verification table employed in a verification method based on a compression result illustrated in FIG. 15;

FIG. 17 is a diagram illustrating an example of comparing the number of nodes in a Markov model with or without compression;

FIG. 18 is a diagram illustrating an example of comparing verification results of reliability of a storage system with or without compression;

FIG. 19 is a diagram illustrating an example of a verification table employed in a verification method based on a Markov model without compression;

FIG. 20 is a flowchart illustrating an exemplary operation of a client apparatus according to an embodiment;

FIG. 21 is a flowchart illustrating an exemplary operation of simplification processing performed by a client apparatus according to an embodiment;

FIG. 22 is a diagram illustrating an exemplary hardware configuration of a client apparatus according to an embodiment;

FIG. 23 is a diagram illustrating an example of a storage system in which an MDS code is applied;

FIG. 24 is a diagram illustrating an example of a storage system in which a non-MDS code is applied;

FIG. 25 is a diagram illustrating an example of a Markov model of a storage system in which an MDS code is applied;

FIG. 26 is a diagram illustrating an example of a Markov model of a storage system in which a non-MDS code is applied; and

FIG. 27 is a diagram illustrating an example of comparing scales of Markov models with respect to a storage system in which an MDS code is applied and a storage system in which a non-MDS code is applied.

### DESCRIPTION OF EMBODIMENT

Hereinafter, an embodiment will be described with reference to the drawings. The below-described embodiment is merely an example, and various types of modifications and application of techniques not clearly disclosed below are not intended to be excluded. In other words, the embodiment may be implemented by being variously modified without departing from the scope of the gist thereof. In the drawings used in the below-described embodiment, a portion having similar reference numeral indicates similar portion unless otherwise stated.

### EMBODIMENT

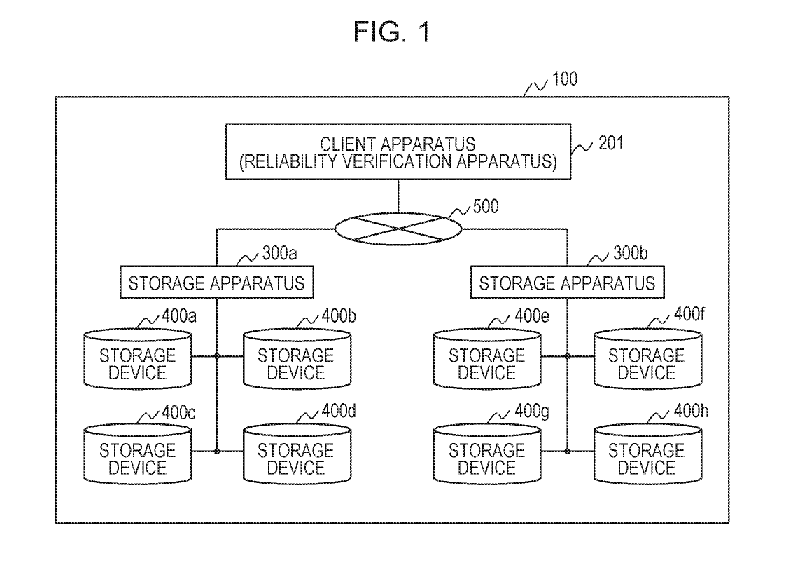

FIG. 1 is a diagram illustrating a storage system 100 according to the embodiment. The storage system 100 includes a client apparatus 201, one or more (two in FIG. 1) storage apparatuses 300a and 300b, and a network 500. Hereinafter, in a case where the storage apparatuses 300a and 300b are not discriminated from each other, any one of the storage apparatuses 300a and 300b will be simply expressed as a storage apparatus 300.

The storage system 100 provides a user with a storage domain of the storage apparatus 300 via the client apparatus 201, for example. The storage system 100 may be a cloud storage system such as a distributed storage, may be a private storage system such as an in-house storage system in which an installation site or a user of the storage apparatus 300 is limited, and may be one of other various storage systems.

The client apparatus 201 is connected to the network 500. For example, the client apparatus 201 is a terminal used by a user of the storage system 100 for access to the storage apparatus 300. As the client apparatus 201, various types of information processing apparatuses such as a PC and a server may be exemplified.

The client apparatus 201 according to the embodiment may include a function of a reliability verification apparatus which verifies the reliability of storages (a plurality of storage devices 400). An apparatus which realizes the function of the reliability verification apparatus is not limited to an apparatus such as the client apparatus 201 which is connected to the network 500. The apparatus may be an information processing apparatus (not illustrated) outside of the storage system 100. In the description below, the client apparatus 201 includes the function of the reliability verification apparatus. However, in a case where the function is included in a different information processing apparatus, the different information processing apparatus may be caused to perform the below-described processing of the client apparatus 201.

The storage apparatus 300a includes a plurality of (four in FIG. 1) storage devices 400a to 400d, and the storage apparatus 300b includes a plurality of (four in FIG. 1) storage devices 400e to 400h. Hereinafter, in a case where the storage devices 400a to 400h are not discriminated from each other, any one of the storage devices 400a to 400h will be simply expressed as a storage device 400. The storage apparatus 300 redundantly set up the plurality of storage devices 400 by utilizing a non-MDS code and issues an instruction such as writing or reading of data with respect to the plurality of storage devices 400 in response to access from the client apparatus 201. As the storage apparatus 300, for example, a disk matrix apparatus may be exemplified.

As a non-MDS code, various types of methods such as repairable fountain codes, regenerating codes, network coding for a distributed storage system, hierarchical codes, and partial MDS codes may be exemplified. The aforementioned non-MDS codes are often developed independently by manufacturers of the storage apparatus and the like. There may be various types of methods other than the aforementioned examples. In the embodiment, the method in which the storage apparatus 300 redundantly sets up the plurality of storage devices 400 is not limited to the aforementioned examples, and various types of methods of a non-MDS code may be used.

The storage device 400 is hardware which stores various types of data, programs, and the like. As the storage device 400, various types of devices, for example, a magnetic disk device such as a hard disk drive (HDD), a semiconductor drive device such as a solid state drive (SSD), and a non-volatile memory such as a flash memory may be exemplified.

A storage device 400 may fail with a fixed probability, and a failed storage device 400 may be restored with a fixed probability through a recovery operation or the like performed by the storage apparatus 300. The failure of the storage device 400 includes, for example, an internal error of the storage device 400, a connection error between the storage device 400 and the storage apparatus 300, an error in an interface or an application of the storage apparatus 300, a temporary error caused by an a wave which hits a sector of the storage device 400 in such a way that a bit becomes inverted, and the like.

The network 500 is a network such as a local area network (LAN) or a storage area network (SAN) to which the client apparatus 201, the storage apparatus 300, and the like are connected. The network 500 may form an intranet, and may be connected to the Internet via a switch (not illustrated) or the like.

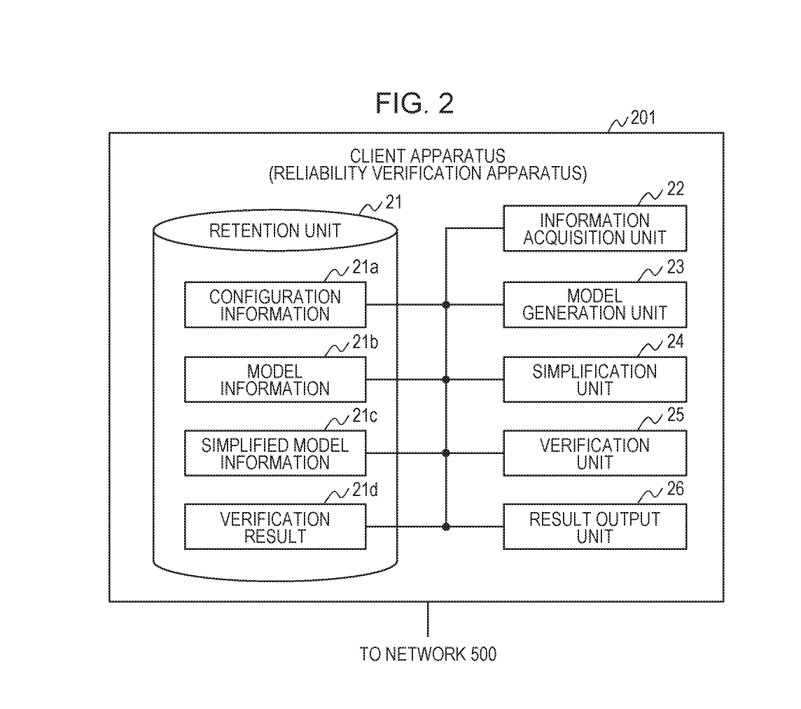

Subsequently, an exemplary functional configuration of the client apparatus 201 according to the embodiment will be described with reference to FIG. 2. The client apparatus 201 calculates, as a reliability verification apparatus, the reliability of a storage system.

As described above, since the storage system 100 utilizes a non-MDS code, when calculating the reliability of a storage system in which a Markov model is applied, a situation such as an increase of a computation time and difficulties in computation may occur. In contrast, the client apparatus 201 according to the embodiment may reduce an amount of computation by simplifying the Markov model of the storage system 100 in which a non-MDS code is applied and reducing the scale thereof so that the reliability of the storage system may be easily calculated.

Therefore, the client apparatus 201 includes a retention unit 21, an information acquisition unit 22, a model generation unit 23, a simplification unit 24, a verification unit 25, and a result output unit 26, for example.

The retention unit 21 is an example of a storage device which stores therein data. As exemplified in FIG. 2, the retention unit 21 retains configuration information 21a, model information 21b, simplified model information 21c, and a verification result 21d.

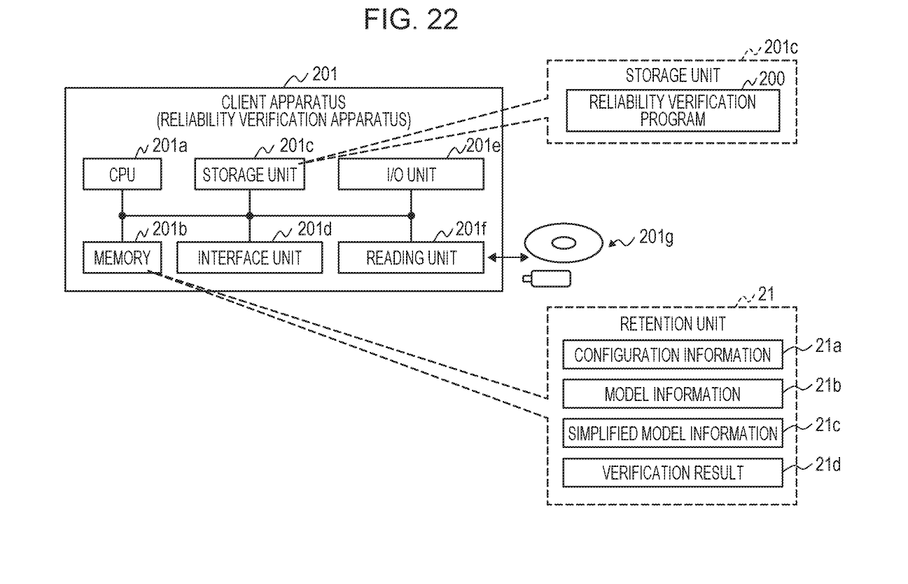

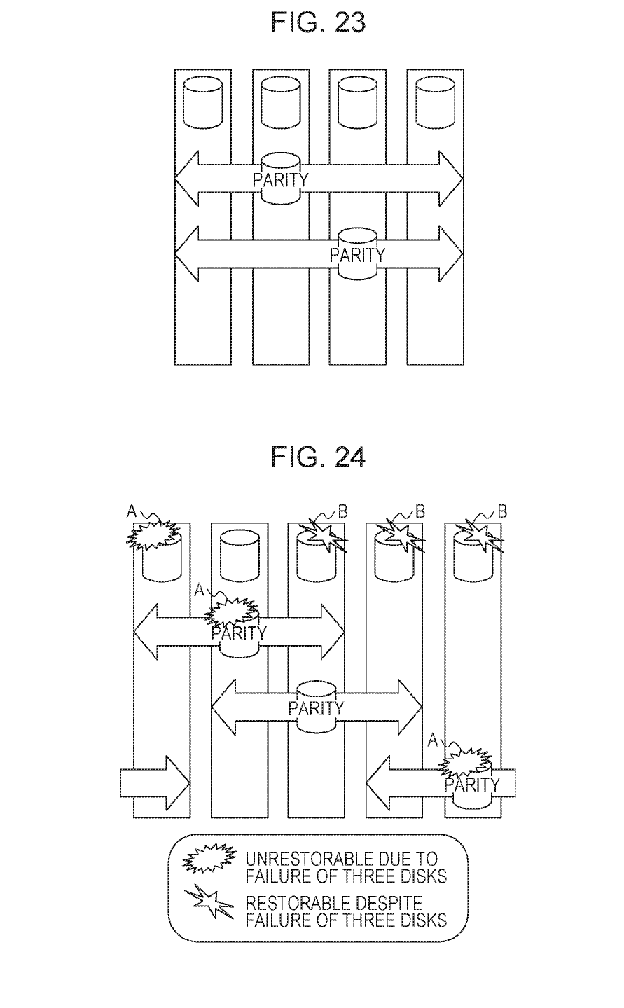

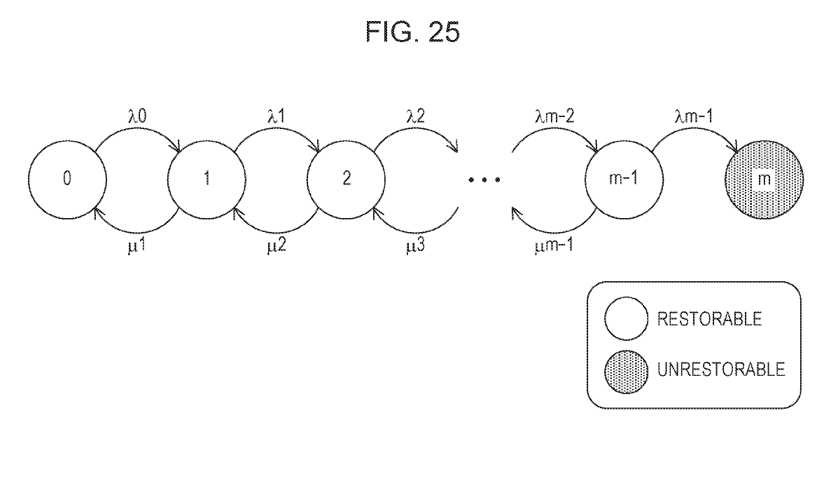

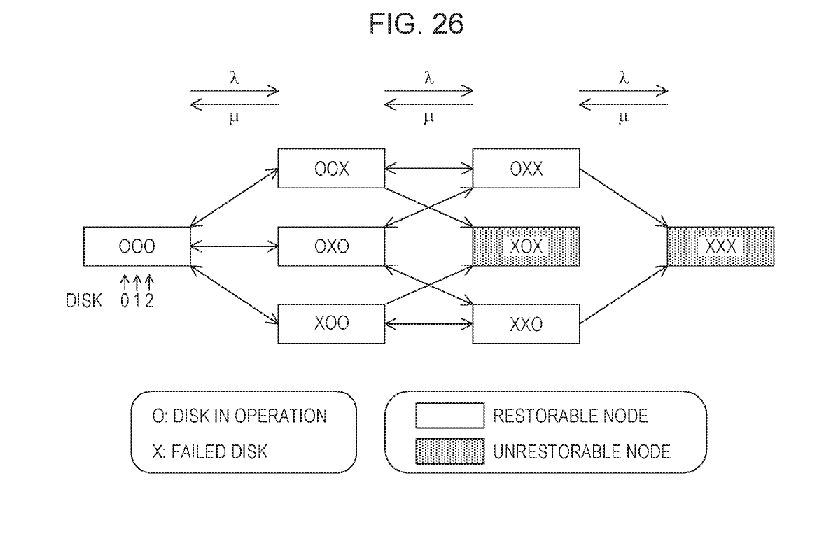

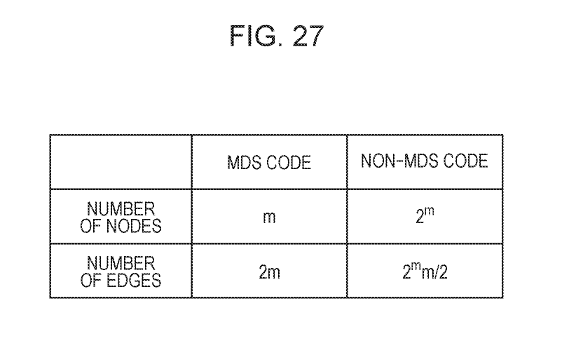

The information acquisition unit 22 acquires the configuration information 21a of the storage system 100 input to the client apparatus 201, thereby storing the configuration information 21a in the retention unit 21. The configuration information 21a includes information related to the number of storage devices 400 included in the storage system 100 and the redundant configuration, and is used for generating the below-described Markov model. For example, it is preferable that an operator who performs verification of the reliability of a storage system examines and decides the configuration information 21a in advance so that the configuration information 21a is input to the client apparatus 201 via an interface unit 201d, an input/output (I/O) unit 201e, a reading unit 201f, or the like (refer to FIG. 22).

The model generation unit 23 generates a Markov model of a storage system on the basis of the configuration information 21a stored in the retention unit 21, thereby storing the generated Markov model in the retention unit 21 as the model information 21b. A process of generating a Markov model performed on the basis of the configuration information 21a may be carried out through various types of known methods, and thus, detailed description thereof will be omitted.

When at least one of the configuration information 21a and the model information 21b is set to the retention unit 21 in advance by a user of the client apparatus 201, for example, the function of at least one of the information acquisition unit 22 and the model generation unit 23 described above may be omitted.

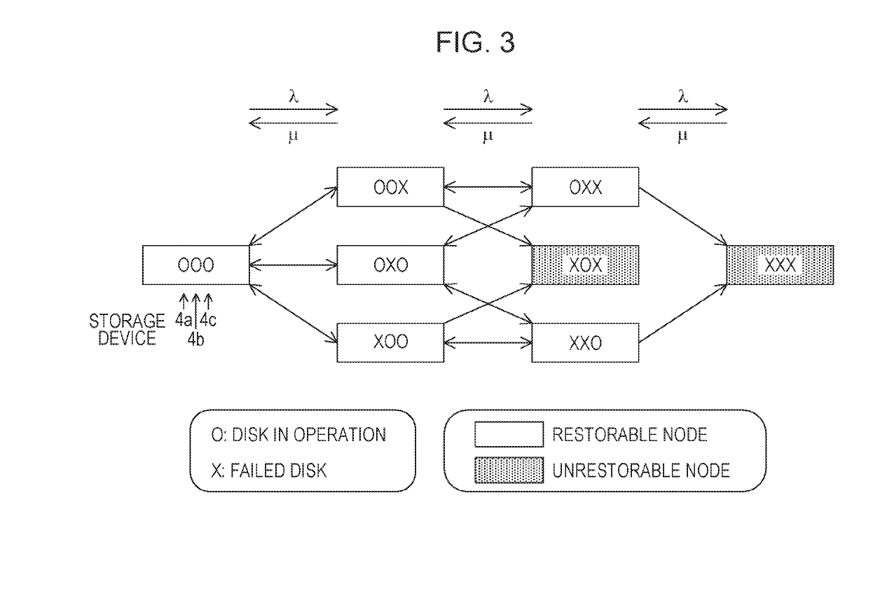

Hereinafter, in order to make the description simple, it is assumed that the storage system 100 includes three storage devices 400 (for example, the storage devices 400a, 400b, and 400c) and that the model generation unit 23 generates a topology (graph) of a Markov model illustrated in FIG. 3. As illustrated in FIG. 3, it is assumed that the respective storage devices 400 have a probability λ of failure during a certain period of time, and the respective failed storage devices 400 have a probability μ of recovery during the certain period of time. An unrestorable node is handled as to be in a state of complete failure so that there is no transition to another node.

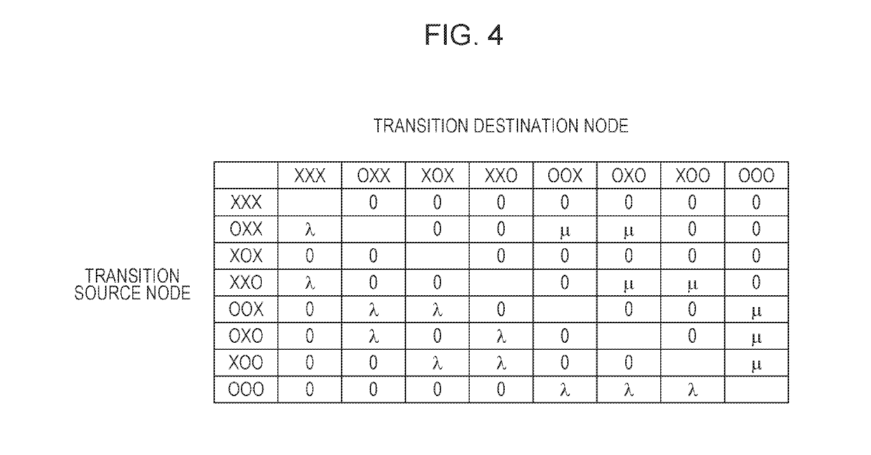

FIG. 3 illustrates a Markov model in a form of a graph so that state transitions may be easily grasped. However, in an information processing apparatus such as the client apparatus 201, the Markov model may be managed in a matrix (a state transition matrix) exemplified in FIG. 4.

When a Markov model is expressed in a matrix, as exemplified in the table illustrated in FIG. 4, the vertical axis indicates nodes of transition sources of state transitions, and the horizontal axis indicates nodes of transition destinations of state transitions. A probability of a state transition is set to the intersection point of a transition source node and a transition destination node. A probability that there is no state transition of a node (a probability of a case where the transition source node and the transition destination node are the same: blank portions in the table illustrated in FIG. 4) is obtained by subtracting a sum of probabilities that a node transitions to other nodes, from 1.0. For example, the probability that there is no state transition of a node (OOO) becomes 1.0−(λ (a probability of transition to a node (OOX))+λ (a probability of transition to a node (OXO))+λ (a probability of transition to a node (XOO)))=1.0−3λ.

Accordingly, a Markov model of the storage system 100 including the plurality of storage devices 400 may be considered to be a model which has nodes corresponding to respective combinations of the presence or absence of failure regarding respective storage devices 400 and indicates state transitions between the nodes. Each node indicates a state of the storage system 100, that is, the presence or absence of failure regarding respective storage devices 400.

The simplification unit 24 simplifies, by using a simplification (compression) algorithm, the model information 21b generated by the model generation unit 23 and generates simplified model information 21c in which the scale of the model is reduced. The simplification unit 24 thereby stores the generated simplified model information 21c in the retention unit 21. The simplification algorithm may include the following processing.

(1) The simplification unit 24 extracts a graph including a certain node (herein, expressed as a node s for convenience) and nodes to which the state of the storage system 100 may transition from the node s due to a failure of a storage device 400. The extracted graph is referred to as a child graph of the node s.

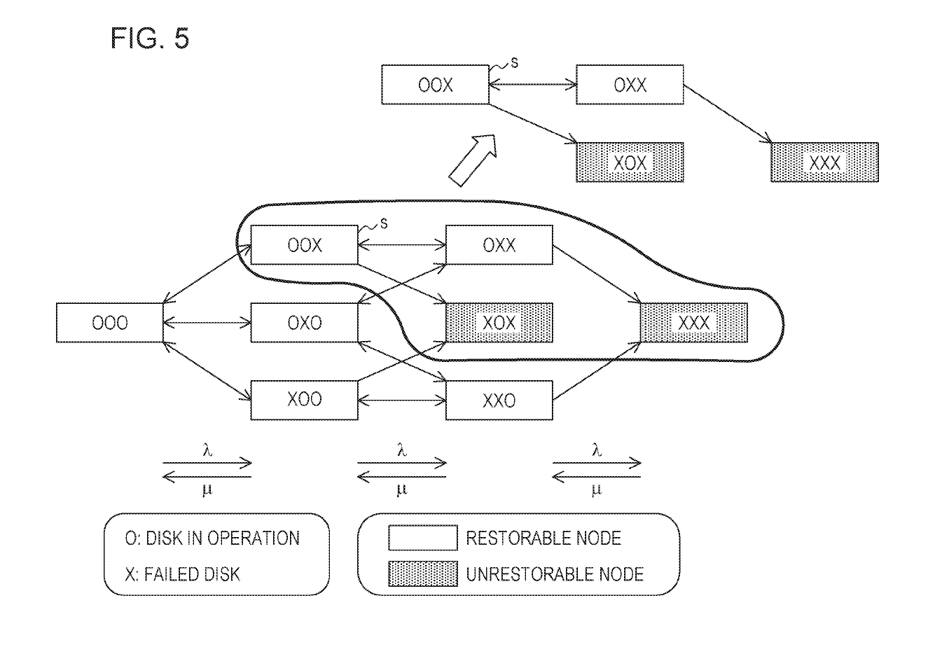

For example, as illustrated in FIG. 5, the child graph of a node s (OOX) extracted by the simplification unit 24 includes the node s (OOX), a node (OXX), a node (XOX), a node (XXX), and edges between the aforementioned nodes. At this time, the simplification unit 24 extracts child graphs of two nodes in order to perform comparison therebetween.

(2) When the two extracted child graphs g1 and g2 are isomorphic to each other, the simplification unit 24 substitutes one child graph for the other child graph. In other words, the simplification unit 24 integrates two isomorphic child graphs into one child graph. A condition for determining two child graphs to be isomorphic to each other is, for example, that the graphs (the child graphs) are identical to each other even when a node of one child graph is substituted with a node of the other child graph. At this time, the substitution may be performed only between restorable nodes and between unrestorable nodes. A condition to be the identical graphs is, for example, that state transitions (e edges) due to a failure are identical to each other before and after the substitution of the nodes of the child graph.

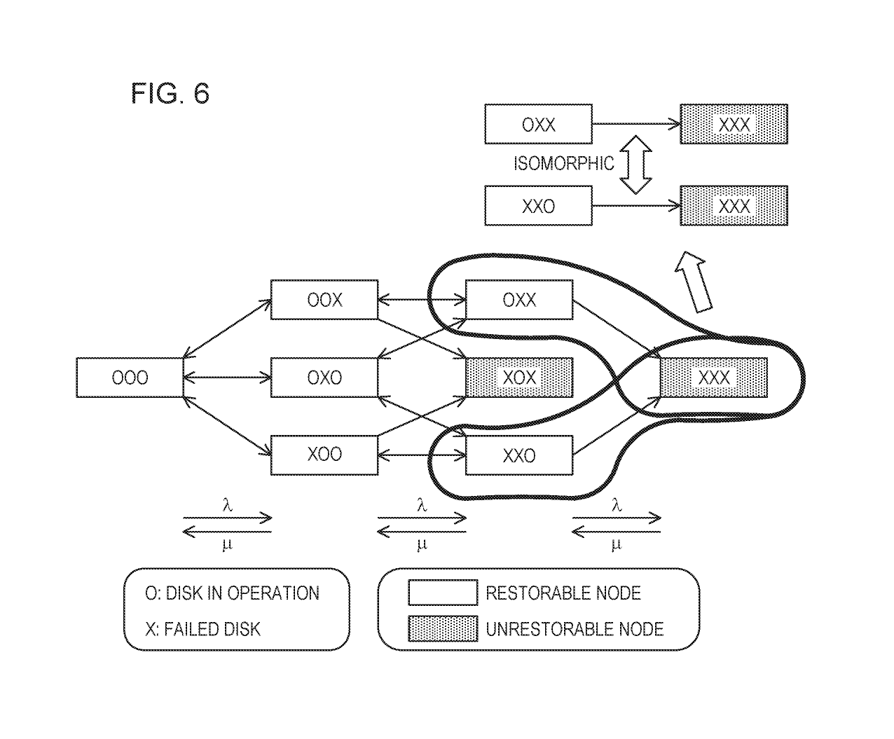

For example, as illustrated in FIG. 6, both the child graph of the node (OXX) and the child graph of a node (XXO) are expressed as graphs in which a state transition from a restorable node (OXX or XXO) to an unrestorable node (XXX) may occur. Accordingly, in the example illustrated in FIG. 6, the simplification unit 24 determines that the child graph of the node (OXX) and the child graph of the node (XXO) are isomorphic to each other. In this case, the simplification unit 24 substitutes one child graph for the other child graph. The detailed method thereof will be described later.

The simplification unit 24 may generate a simplified model information 21c obtained by simplifying the model information 21b, on the basis of the simplification algorithm exemplified in (1) and (2) described above. The detailed processing performed by the simplification unit 24 will be described later.

In (2), a reason for allowing the substitution (integration into one) of the child graphs determined to be isomorphic to each other by the simplification unit 24 is that the probabilities λ and μ of state transitions of the storage device 400 are small in a model such as a Markov model. In other words, since the probabilities λ and μ are small, the probability of state transitions occurring several times between the nodes is remarkably reduced so that the calculation results substantially match with each other even when graphs (child graphs) which match with each other in a narrow domain in one graph are taken to be identical to each other.

The verification unit 25 performs verification (evaluation) of the reliability of the storage system on the basis of the simplified model information 21c generated (modified) by the simplification unit 24.

For example, the verification unit 25 calculates the probability that there is no occurrence of unrestorable failure (being in operation continuously) in the storage after the elapse of a predetermined period of time on the basis of the simplified model information 21c. The probability may be considered to be a value (information related to the reliability) which indicates the reliability of the storage system. The verification unit 25 stores the calculated result in the retention unit 21 as the verification result 21d. The detailed processing performed by the verification unit 25 will be described later.

The result output unit 26 outputs the verification result 21d obtained by the verification unit 25 to an operator. For example, the result output unit 26 may output the verification result 21d to an external device of the client apparatus 201 via the interface unit 201d or the reading unit 201f of the client apparatus 201 (refer to FIG. 22), or the result output unit 26 may cause a monitor as the I/O unit 201e (refer to FIG. 22) to display the verification result 21d. A method of outputting the verification result 21d is not limited to the above-described method, and various types of methods may be applied thereto.

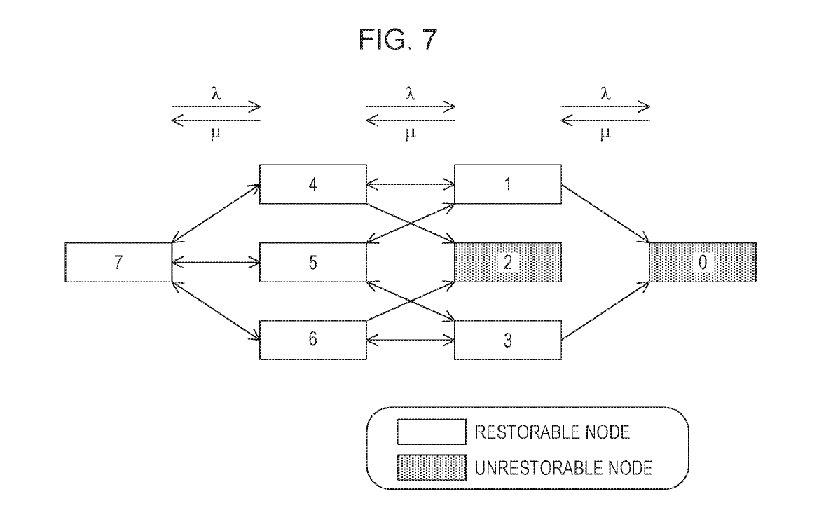

Hereinafter, the simplification unit 24 and the verification unit 25 will be described in detail with reference to FIGS. 7 to 16.

First, simplification processing performed by the simplification unit 24 will be described in detail. The simplification unit 24 performs the following processing from (i) to (iv), for example, during simplification processing performed on the basis of the simplification algorithm exemplified in (1) and (2) described above.

(i) The simplification unit 24 sets serial numbers (node numbers) to the respective nodes in order starting from a node having more failed storage devices 400, with respect to the model information 21b.

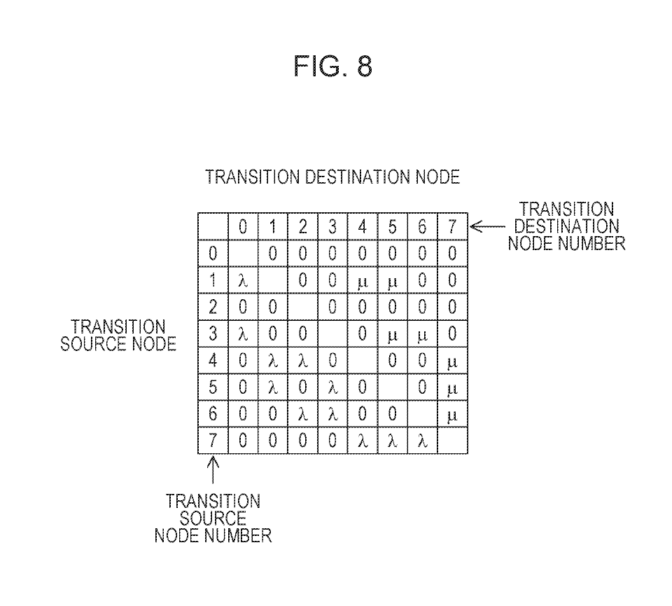

For example, as illustrated in FIG. 7, the simplification unit 24 sets serial numbers 0 to 7 in order starting from the node having the most failed storage devices 400 in the Markov model illustrated in FIG. 3 to the node having the least failed storage devices 400 in a sequential manner of the node (XXX), the node (OXX), . . . , the node (OOX), . . . , and the node (OOO). FIG. 8 illustrates a matrix in a case where the serial numbers are set to the nodes. Hereinafter, the respective nodes having the serial numbers (the node numbers) 0 to 7 are expressed as a node 0, a node 1, . . . , and a node 7.

(ii) The simplification unit 24 selects two nodes different from each other and thereby determines whether or not the child graphs of the two nodes are isomorphic to each other.

For example, the simplification unit 24 selects two nodes from the table illustrated in FIG. 8 and searches, with respect to the respective selected nodes (first nodes), for nodes (transition destination nodes: second nodes) to which the state of the storage system 100 may transition from the respective selected nodes. At this time, with reference to a row of the transition source node number corresponding to the node number of the selected node in the table, the simplification unit 24 determines whether or not probabilities (for example, values including the probability λ) of failure are set to the row. When probabilities of failure are set to the row, the simplification unit 24 may detect the transition destination nodes by acquiring the transition destination node numbers corresponding to respective locations (columns) in which the probabilities of failures are set.

After the transition destination nodes are searched for with respect to the two selected nodes, the simplification unit 24 compares the numbers of the respective transition destination nodes detected with respect to the two selected nodes and thereby determines whether or not the both numbers match with each other. When the both numbers do not match with each other, for example, when no transition destination node is detected with respect to only one of the two selected nodes, or when the numbers of the transition destination nodes detected with respect to the two selected nodes do not match with each other, the simplification unit 24 may determine that the two child graphs are not isomorphic to each other at this moment.

For example, when the selected nodes are the node 0 and the node 1, the probability λ is not set to the row of the transition source node 0 (the number of transition destination nodes=0) as illustrated in FIG. 8, and the probability λ is set to the row of the transition source node 1 in the column of the transition destination node 0 (the number of transition destination nodes=1). In this case, regarding the selected nodes 0 and 1, since the numbers of transition destination nodes do not match with each other, the simplification unit 24 determines that the child graph of the node 0 and the child graph of the node 1 are not isomorphic to each other.

When the numbers of the transition destination nodes detected with respect to the two selected nodes match with each other, the simplification unit 24 performs search for “next transition destination nodes” to which the state of the storage system 100 may transition from each of the transition destination nodes detected with respect to the two selected nodes and performs comparison and matching determination of the numbers of “next transition destination nodes” related to the two selected nodes. The simplification unit 24 recursively performs the search for “next transition destination nodes” and the comparison and matching determination of the numbers of “next transition destination nodes” until the processing of the simplification unit 24 reaches the transition destination nodes at the end in state transitions due to a failure. The transition destination nodes at the end are nodes having no transition destination node to which a state transition due to a failure is performed from the nodes, thereby becoming an unrestorable node.

The processing of the search for “next transition destination nodes” is similar to a case of the search for transition destination nodes from the selected nodes. For example, with reference to the row of the transition source node number corresponding to the node number of the transition destination node in the table, the simplification unit 24 acquires the transition destination node numbers corresponding to the locations (the columns) in which the probability of failure is set in the row.

The processing of the comparison and matching determination of the numbers of “next transition destination nodes” related to the two selected nodes are similar to a case of the above-described processing of the comparison and matching determination of the numbers of the transition destination nodes detected with respect to the two selected nodes. For example, when the numbers of “next transition destination nodes” related to the two selected nodes do not match with each other, the simplification unit 24 determines that the two child graphs are not isomorphic to each other at this moment. In a case where both thereof match with each other, the simplification unit 24 performs the aforementioned comparison and matching determination regarding a “next transition destination node” which is detected but is not yet subjected to the comparison and matching determination in addition to “next transition destination nodes” which have been already subjected to the comparison and matching determination. When there is no “next transition destination node” which is not yet subjected to the comparison and matching determination, the simplification unit 24 searches for transition destination nodes to which the state of the storage system 100 may transition from the “next transition destination nodes”.

In accordance with the above-described processing, the simplification unit 24 performs the processing of the search and the comparison and matching determination regarding the selected nodes (the first nodes) and all of the transition destination nodes (the second nodes) with respect to the two child graphs. Then, when relationships of the state transitions (edges) of the nodes of the two child graphs are determined to be identical to each other, the simplification unit 24 determines that the two child graphs are isomorphic to each other. The expression “relationships of the state transitions (edges) of the nodes of the two child graphs are identical to each other” denotes that the numbers of transition destination nodes are the same as each other between the two child graphs with respect to all of the nodes which are subjected to the comparison and matching determination, and connection topology of the nodes are identical to each other between the two child graphs.

For example, as illustrated in FIG. 8, when the selected nodes are the node 1 and the node 3, the probability λ is set to the row of the transition source node 1 in the column of the transition destination node 0 (the number of transition destination nodes=1), and the probability λ is also set to the row of the transition source node 3 in the column of the transition destination node 0 (the number of transition destination nodes=1). In this case, since the numbers of transition destination nodes match with each other between the selected nodes 1 and 3, the simplification unit 24 searches for “next transition destination nodes” regarding the two transition destination nodes (node 0 and node 0).

Since there is no “next transition destination node” with respect to the node 0 (the number of transition destination nodes=0), the simplification unit 24 determines that the number of “next transition destination nodes” of transition destination nodes of the selected node 1 and the number of “next transition destination nodes” of transition destination nodes of the selected node 3 match with each other. Moreover, since there is no transition destination node from the node 0, the simplification unit 24 determines that the processing of the simplification unit 24 reaches the transition destination node at the end in state transitions due to a failure, that is, it is determined that the comparison and matching determination has resulted in “matched” without exception). Accordingly, the simplification unit 24 may determine that the child graph of the selected node 1 and the child graph of the selected node 3 are isomorphic to each other. In this case, the child graph of the selected node 1 has the node 1 and the node 0, and the child graph of the selected node 3 has the node 3 and the node 0.

When both the numbers of the transition destination nodes detected with respect to the two selected nodes are 0 and match with each other, the simplification unit 24 determines that each of the selected nodes itself forms a child graph and the two child graphs are isomorphic to each other.

For example, as illustrated in FIG. 8, when the selected nodes are the node 0 and the node 2, the probability λ is not set to the row of the transition source node 0 (the number of transition destination nodes=0), and the probability λ is also not set to the row of the transition source node 2 (the number of transition destination nodes=0). In this case, since the numbers of the transition destination nodes are 0 and match with each other between the selected nodes 0 and 2, the simplification unit 24 may determine that each of the two selected nodes 0 and 2 itself forms a child graph and the two child graphs are isomorphic to each other.

In this manner, since the simplification unit 24 extracts child graphs which are aggregations (node groups) of one or more nodes and performs the comparison and matching determination in stages with respect to at least a portion of the child graphs, a determination such that the two child graphs are not isomorphic to each other may be made in an early stage. Accordingly, extraction of two child graphs which are not isomorphic to each other may be suppressed. Thus, simplification processing may be accelerated.

It is preferable that the simplification unit 24 selects nodes having lower node numbers as the two selected nodes which are different from each other. Here, a node having a lower node number is a node closer to the end in state transitions due to a failure of the storage device 400 in a Markov model. In the above-described processing of the search for “next transition destination nodes” and the comparison and matching determination of the numbers of “next transition destination nodes”, the processing is performed by tracing the transition destinations of the nodes in order. Therefore, it is possible to perform the processing from transition destination nodes which are closer to the end and have a relatively shorter processing time by selecting two nodes having lower node numbers as the selected nodes.

The processing of the comparison and matching determination regarding the two child graphs may be performed along with the search for the nodes of the two child graphs as described above, and may also be performed after detecting all of the nodes in the two child graphs. For example, the simplification unit 24 detects (extracts) nodes in a range from the selected node to transition destination nodes at the end in state transitions due to a failure as a child graph of the selected node with respect to each of the two selected nodes by using the above-described method. Then, when relationships of the state transitions (edges) of the nodes of the two child graphs are determined to be identical to each other, the simplification unit 24 determines that the two child graphs are isomorphic to each other.

When determining whether or not the two child graphs are isomorphic to each other, the simplification unit 24 does not have to consider the probability μ of recovery of the storage device 400. The probability λ of failure and the probability μ of recovery are basically included in a state transition between restorable nodes in the graph (refer to the arrows of the probabilities λ and μ in FIG. 7). Therefore, it is sufficient to determine whether or not the child graphs are isomorphic to each other when the probability λ of failure is considered.

According to the above-described premise, a state transition between a restorable node and an unrestorable node includes only the probability λ of failure from the restorable node to the unrestorable node, and the state transition therebetween does not include the probability μ of recovery in a reverse direction. This condition may be applied as a determination reference for the simplification unit 24 discriminating the unrestorable node. In other words, when the row of the transition source node number corresponding to a certain node does not include a probability (a value including the probability μ) of recovery to another node, the simplification unit 24 may determine that the certain node is a transition destination node at the end.

(iii) When the two child graphs are isomorphic to each other as a determination result of (ii) described above, the simplification unit 24 overlaps one child graph with the other child graph, thereby deleting the one child graph (integrating the two selected nodes which are isomorphic to each other into one node).

For example, the simplification unit 24 reconnects all of edges for transition to the selected node of one of the two child graphs which are determined to be isomorphic to each other, into the selected node of the other child graph. The simplification unit 24 deletes the selected node of the one child graph and the edges for transition from the selected node. It is preferable that the one child graph to be deleted is a child graph of the selected node having a higher node number. As described above, in the above-described processing of the search for “next transition destination nodes” and the comparison and matching determination of the numbers of “next transition destination nodes”, the processing is performed by trancing the transition destinations of the nodes in order. Therefore, it is possible to shorten the processing time taken for the following processing by deleting the child graph of the node having a higher node number.

For example, description will be given regarding processing in a case where the simplification unit 24 determines that the child graph of the node 0 and the child graph of the node 2 are isomorphic to each other.

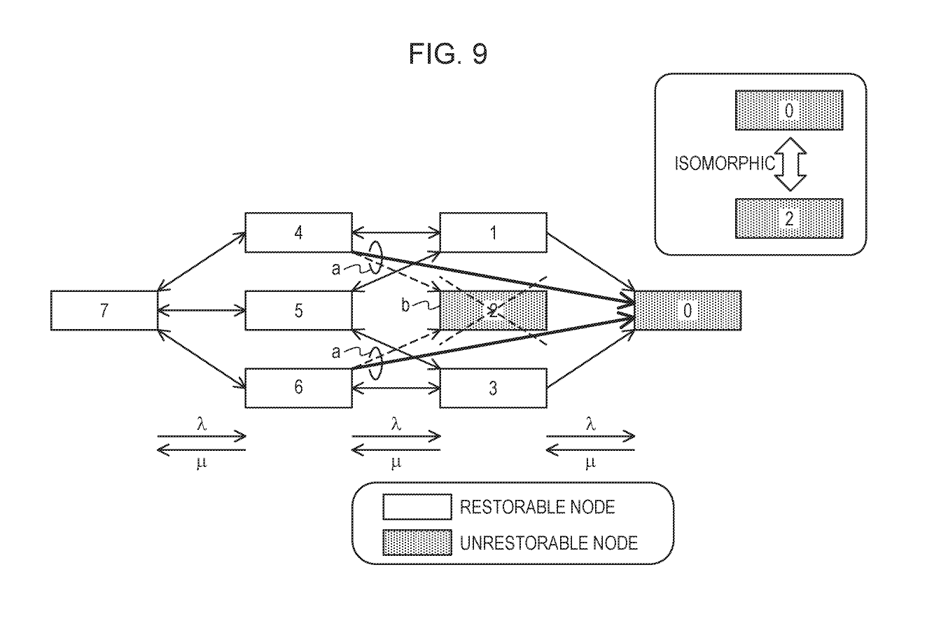

As illustrated in FIG. 9, the simplification unit 24 reconnects the edges for transition to the selected node 2 having a higher node number, to the remaining selected node 0 (a in FIG. 9), and deletes the selected node 2 (b in FIG. 9). Accordingly, state transitions from the node 4 and the node 6 to the selected node 2 are substituted with state transitions to the selected node 0, and the selected node 2 (the transition destination node) which desires no state transition from the node 4 and the node 6 is deleted.

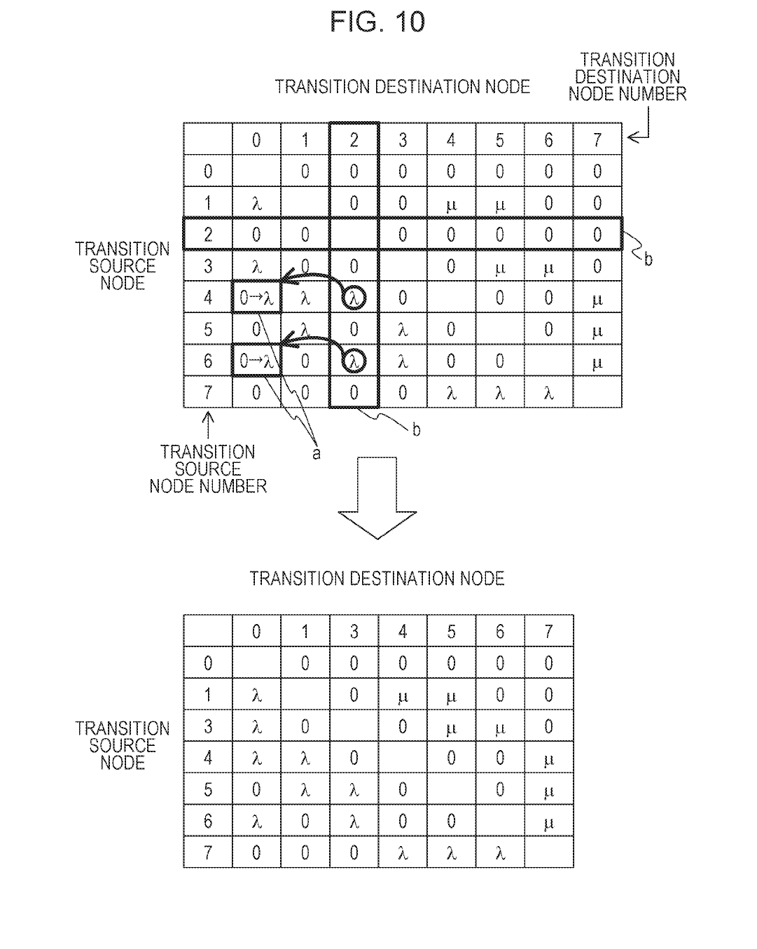

FIG. 10 illustrates an example in which the simplification unit 24 performs the processing illustrated in FIG. 9 with respect to the matrix. The simplification unit 24 moves (adds) the probability λ of failure which is set to two locations in the column of the transition destination node 2 to the column of the transition destination node 0 in the same rows (the transition source nodes 4 and 6) (a in the upper table in FIG. 10). The simplification unit 24 also deletes the row of the transition source node 2 and the column of the transition destination node 2 from the table (b in the upper table in FIG. 10).

As illustrated in the lower table in FIG. 10, in the table after the child graph of the node 2 is deleted, the state transition destinations of the transition source nodes 4 and 6 are switched from the transition destination node 2 to the transition destination node 0, and the selected node 2 is also deleted.

(iv) the simplification unit 24 repeats a series of processing (ii) and (iii) described above until the series of processing (ii) and (iii) are performed with respect to all of the nodes.

For example, with respect to all of combinations of two selected nodes, the simplification unit 24 performs the processing (ii) and (iii) described above in order starting from nodes having lower node numbers, that is, the processing from the selection of the two selected nodes (the first nodes) to the integration of the selected nodes in order by changing the combinations of the two selected nodes.

Hereinafter, description will be given regarding the processing (iii) described above when it is determined that the child graph of the node 1 and the child graph of the node 3 are isomorphic to each other as a result of the processing (ii) described above performed by the simplification unit 24 in a state where the node 2 is integrated with the node 0 as illustrated in FIGS. 9 and 10.

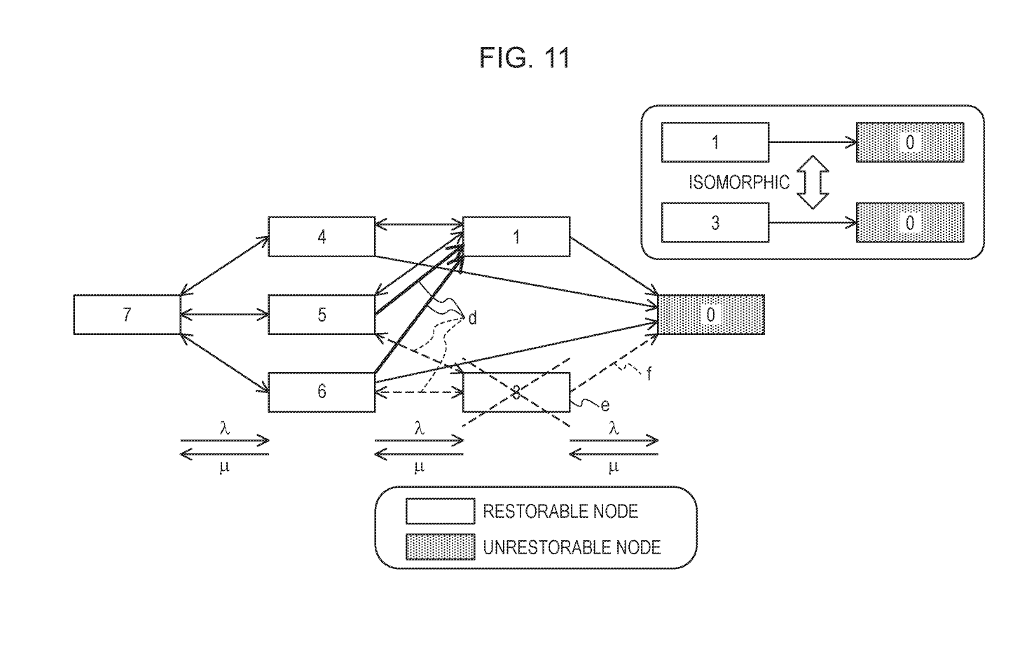

As illustrated in FIG. 11, the simplification unit 24 reconnects the edges for transition to the selected node 3 having a higher node number, to the remaining selected node 1 (d in FIG. 11), and deletes the selected node 3 (e in FIG. 11). The simplification unit 24 also deletes the edge for transition from the deleted selected node 3 (f in FIG. 11). Accordingly, state transitions from the node 5 and the node 6 to the selected node 3 are substituted with state transitions to the selected node 1, and the selected node 3 (the transition destination) which desires no state transition from the node 5 and the node 6 and desires no state transition to the node 0 is deleted.

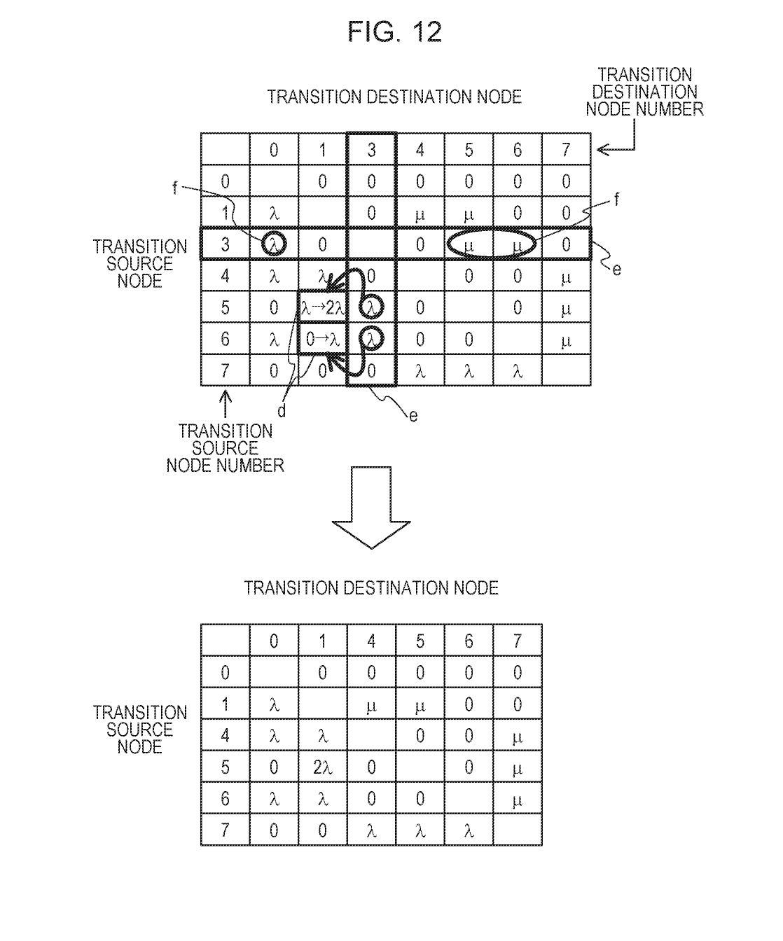

FIG. 12 illustrates an example in which the simplification unit 24 performs the processing illustrated in FIG. 11 with respect to the matrix. The simplification unit 24 moves (adds) the probability λ of failure which is set to two locations in the column of the transition destination node 3 to the column of the transition destination node 1 in the same rows (the transition source nodes 5 and 6) (d in the upper table in FIG. 12). The probability λ of failure is already set to the intersection point of the row of the transition source node 5 and the column of the transition destination node 1. In this case, the simplification unit 24 calculates a probability 2λ obtained by adding the probability λ of failure set to the column of the transition destination node 3 to the probability λ set to the intersection point, thereby setting the probability 2λ to the intersection point.

the simplification unit 24 also deletes the row of the transition source node 3 and the column of the transition destination node 3 from the table (e in the upper table in FIG. 12). With this processing, the state transition (the probability λ of failure) from the selected node 3 to the transition destination node 0 and the state transitions (the probability μ of recovery) to the transition source nodes 5 and 6 are deleted (f in the upper table in FIG. 12), and deletion of the edges for transition from the selected node 3 is also performed.

As illustrated in the lower table in FIG. 12, in the table after the child graph of the node 3 is deleted, the state transition destinations of the transition source nodes 5 and 6 are switched from the transition destination node 3 to the transition destination node 1, and the selected node 3 is also deleted.

Subsequently, description will be given regarding the processing (iii) described above when it is determined that the child graph of the node 4 and the child graph of the node 6 are isomorphic to each other as a result of the processing (ii) described above performed by the simplification unit 24 in a state where the node 3 is integrated with the node 1 as illustrated in FIGS. 11 and 12.

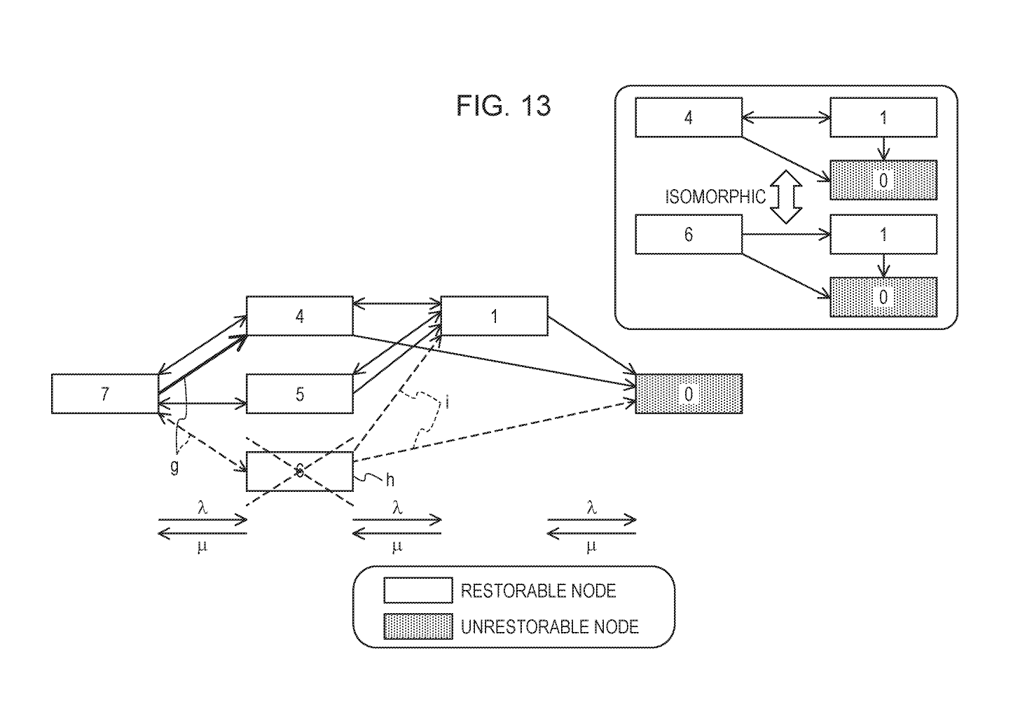

As illustrated in FIG. 13, the simplification unit 24 reconnects the edge for transition to the selected node 6 having a higher node number, to the remaining selected node 4 (g in FIG. 13), and deletes the selected node 6 (h in FIG. 13). The simplification unit 24 also deletes the edges for transition from the deleted selected node 6 (i in FIG. 13). Accordingly, a state transition from the node 7 to the selected node 6 is substituted with a state transition to the selected node 4, and the selection node 6 (the transition destination) which desires no state transition from the node 7 and desires no state transition to the node 1 and the node 0 is deleted.

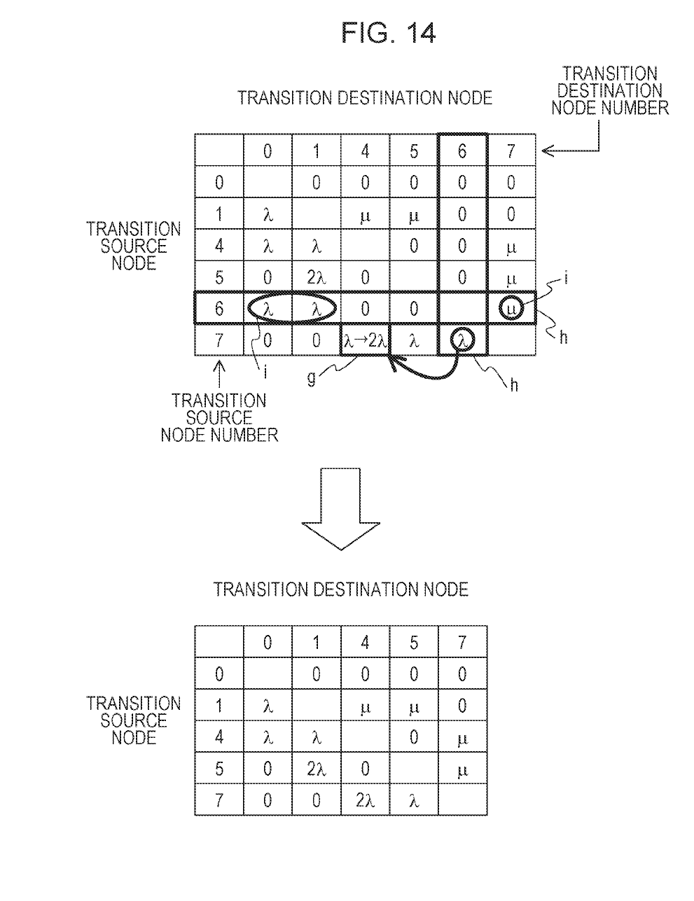

FIG. 14 illustrates an example in which the simplification unit 24 performs the processing illustrated in FIG. 13 with respect to the matrix. The simplification unit 24 moves (adds) the probability λ of failure which is set to the column of the transition destination node 6 to the column of the transition destination node 4 in the same row (the transition source node 7) (g in the upper table in FIG. 14). The probability λ of failure is already set to the intersection point of the row of the transition source node 7 and the column of the transition destination node 4. In this case, the simplification unit 24 calculates a probability 2λ obtained by adding the probability λ of failure set to the column of the transition destination node 6 to the probability λ set to the intersection point, thereby setting the probability 2λ to the intersection point.

The simplification unit 24 also deletes the row of the transition source node 6 and the column of the transition destination node 6 from the table (h in the upper table in FIG. 14). With this processing, the state transitions (the probability λ of failure) from the selected node 6 to the transition destination nodes 0 and 1, and the state transition (the probability μ of recovery) to the transition source node 7 are deleted (i in the upper table in FIG. 14), and deletion of the edges for transition from the selected node 6 is also performed.

As illustrated in the lower table in FIG. 14, in the table after the child graph of the node 6 is deleted, the state transition destination of the transition source node 7 is switched from the transition destination node 6 to the transition destination node 4, and the selected node 6 is also deleted.

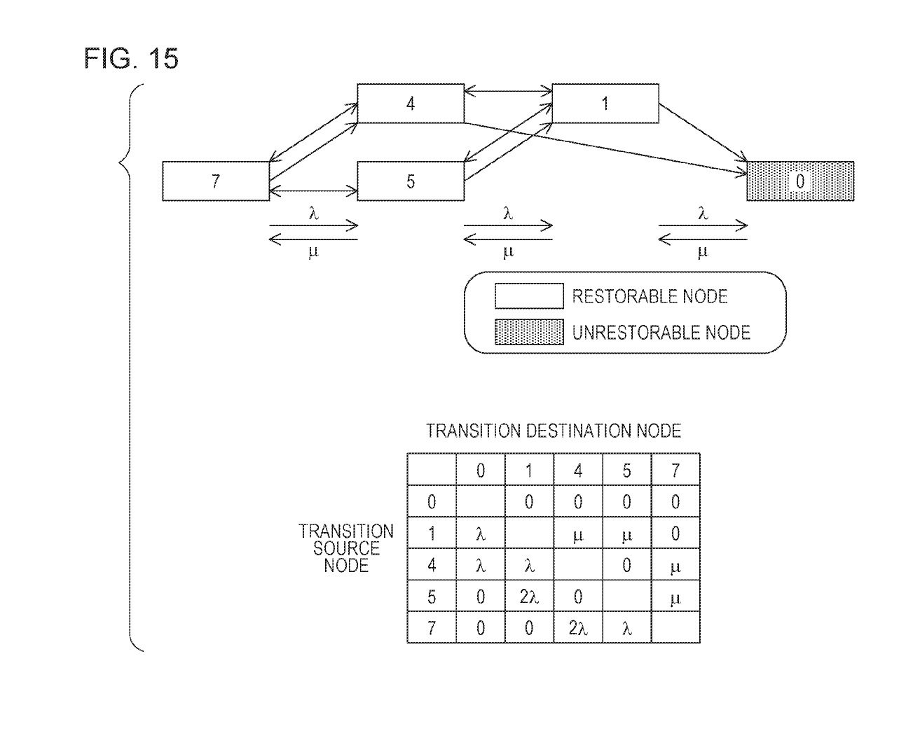

As described above, the simplification unit 24 repeats the series of processing (ii) and (iii) described above until the series of processing (ii) and (iii) are performed with respect to all of the nodes, thereby ending the simplification processing of the model information 21b. For example, when the simplification processing ends, the Markov model illustrated in FIGS. 7 and 8 is simplified (compressed) to the Markov model illustrated in FIG. 15.

When the simplification processing described above ends, the simplification unit 24 stores the simplified Markov model in the retention unit 21 as the simplified model information 21c (the matrix in FIG. 15). The simplification unit 24 may modify (transform) the model information 21b during the process of the simplification processing instead of newly generating simplified model information 21c, and may treat the modified model information 21b as the simplified model information 21c.

Hereinbefore, the simplification unit 24 is described to select two selected nodes in the simplification processing. However, the selection is not limited thereto. For example, the simplification unit 24 may select three or more selected nodes. Then, when the child graphs of two or more selected nodes in the aforementioned selected nodes are determined to be isomorphic to each other, the two or more selected nodes may be integrated with each other.

As described above, the simplification unit 24 is an example of an integration unit which performs the following processing. The simplification unit 24 as the integration unit selects, from a plurality of the nodes, a plurality of the first nodes different from each other on the basis of the model information 21b. The simplification unit 24 acquires information related to state transitions due to a failure of the storage device 400 from each of the selected first nodes. The simplification unit 24 as the integration unit integrates two or more first nodes into one first node when the acquired information related to state transitions from the two or more first nodes satisfies a predetermined condition.

The verification unit 25 performs processing of verifying the reliability of the storage system 100 on the basis of the following verification algorithm, for example.

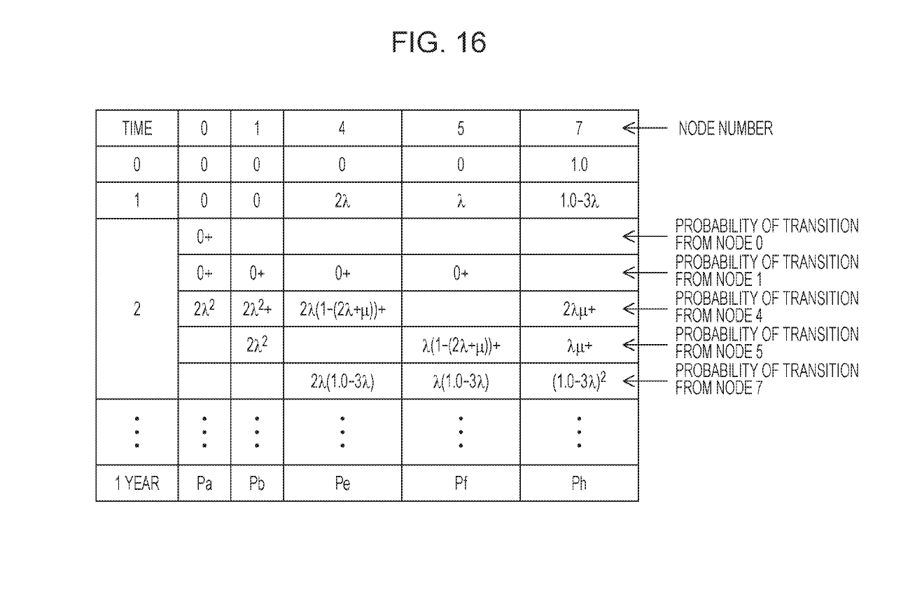

The verification algorithm may include the following processing. For example, the verification unit 25 generates a verification table in which probabilities that the state of the storage system 100 exists at the respective nodes at certain timing is expressed in a one-dimensional matrix as illustrated in FIG. 16 on the basis of the simplified model information 21c. The verification unit 25 updates the one-dimensional matrix for every certain period of time (unit time) on the basis of the state transition matrix (the table in FIG. 15), thereby calculating a probability of existing at restorable nodes after the elapse of a predetermined period of time (for example, one year).

For example, the verification unit 25 considers an initial state in which none of the storage devices 400 is failed, as a state where all of the storage devices 400 are in operation (the node 7). The verification unit 25 updates the one-dimensional matrix in accordance with the probabilities of transitions from the node 7 to the node 4 and the node 5 with respect to the time 1 which is timing after the elapse of a certain period of time starting from the time 0. Moreover, the verification unit 25 updates the one-dimensional matrix in accordance with the probabilities of transitions from the nodes 4, 5, and 7 to each of the nodes with respect to the time 2 which is timing after the elapse of the certain period of time starting from the time 1.

In this manner, the verification unit 25 updates the one-dimensional matrix at timing for every certain period of time (unit time) starting from the initial state, thereby obtaining the probability at the time when the timing reaches the predetermined period of time.

For example, the verification unit 25 fills the verification table with items (node numbers) by using the node numbers included in the simplified model information 21c, as illustrated in FIG. 16. Since the verification unit 25 is assumed that all of the storage devices 400 operate normally in the initial state, 0 is set to the node 0, the node 1, the node 4, and the node 5 with respect to the entry (the one-dimensional matrix) of the time (timing) 0, and 1.0 (100%) is set to the node 7 corresponding to the node (OOO). The value set to each of the nodes in the verification table is a value representing the probability that the plurality of storage devices 400 are in a state of the combination of failures indicated by the node at a certain time (timing).

Subsequently, the verification unit 25 generates an entry of the time 1 (updates the verification table). As illustrated in FIG. 15, since the transition destination node of the node 7 is the node 4 (the probability of failure=2λ) and the node 5 (the probability of failure=λ), as illustrated in FIG. 16, the verification unit 25 sets 2λ to the node 4 and sets λ to the node 5 with respect to the entry of the time 1. The probability that the state of the storage system 100 still exists at the node 7 even after the elapse of a certain period of time (no state transition) is obtained by subtracting, from 1.0, the probabilities of the state transitions from the node 7 to other nodes. Therefore, the verification unit 25 sets 1.0−(2λ+λ)=1.0−3λ to the node 7 with respect to the entry of the time 1.

Subsequently, the verification unit 25 generates an entry of the time 2 (updates the verification table). As illustrated in FIG. 15, state transitions may occur to the node 0 with the probability λ of failure from each of the node 1 (the probability=0 at the time 1) and the node 4 (the probability=2λ at the time 1). However, since the probability of the node 1 at the time 1 is 0, the probability of the state transition from the node 1 to the node 0 at the time 2 is 0. Since the probability of the node 4 at the time 1 is 2λ, the probability of the state transition from the node 4 to the node 0 at the time 2 becomes a value obtained by multiplying the probability 2λ of the node 4 at the immediately preceding time 1, by the probability λ of the transition from the node 4 to the node 0 during the period from the time 1 to the time 2. Since the node 0 is an unrestorable node, the probability that the state of the storage system 100 still exists at the node 0 even after the elapse of a certain time is 1.0 (100%). However, since the probability of the node 0 at the time 1 is 0, the probability that the state of the storage system 100 still exists at the node 0 at the time 2 becomes 0×1.0=0.

Therefore, as illustrated in FIG. 16, the verification unit 25 sets 2λ×λ=2λ² to the node 0 with respect to the entry of the time 2 as the probability of transition from the node 4. Meanwhile, the verification unit 25 sets 0×λ=0 and 0×1.0=0 to each of the probability of transition from the node 1 and the probability that the state of the storage system 100 still exists at the node 0 at the time 2.

As illustrated in FIG. 15, a state transition may occur to the node 1 with the probability λ of failure from the node 4 (the probability=2λ at the time 1), and a state transition may occur to the node 1 with the probability 2λ of failure from the node 5 (the probability=λ at the time 1). The probability of the state transition from the node 4 to the node 1 at the time 2 is calculated by 2λ×λ=2λ² similar to the calculation for the node 0. The probability of the state transition from the node 5 to the node 1 at the time 2 is also calculated by λ×2λ=2λ². Therefore, as illustrated in FIG. 16, the verification unit 25 sets 2λ² to the node 1 with respect to the entry of the time 2 as the probability of transition from each of the node 4 and the node 5. Meanwhile, 0 is set to the probability that the state of the storage system 100 still exists at the node 1 at the time 2.

Moreover, as illustrated in FIG. 15, a state transition may occur to the node 4 from the node 1 (the probability=0 at the time 1) with the probability μ of recovery, and a state transition may occur to the node 4 from the node 7 (the probability=1.0−3λ at the time 1) with the probability 2λ of failure. However, since the probability of the node 1 at the time 1 is 0, the probability of the state transition from the node 1 to the node 4 at the time 2 is 0. Meanwhile, the probability of the state transition from the node 7 to the node 4 at the time 2 is calculated by (1.0−3λ)×2λ=2λ (1.0−3λ) similar to the above-described calculation. The probability that the state of the storage system 100 still exists at the node 4 even at the time 2 is obtained by multiplying the probability 2λ of the node 4 at the time 1 by a value which is obtained by subtracting, from 1.0, the probabilities of the state transitions from the node 4 to other nodes. In other words, the probability that the state of the storage system 100 still exists at the node 4 at the time 2 is calculated by 2λ×(1−(the probability 2λ of transition to the node 0 or the node 1+the probability μ of transition to the node 7))=2λ (1−(2λ+μ)).

Therefore, as illustrated in FIG. 16, the verification unit 25 sets 0 and 2λ (1.0−3λ) to the node 4 with respect to the entry of the time 2 as the probabilities of transitions from the nodes 1 and 7, respectively. Meanwhile, the verification unit 25 sets 2λ (1−(2λ+μ)) to the probability that the state of the storage system 100 still exists at the node 4 at the time 2.

Calculation for the node 5 is basically similar to that for the node 4. For example, as illustrated in FIG. 16, the verification unit 25 sets 0 and λ (1.0−3λ) to the node 5 with respect to the entry of the time 2 as the probabilities of transitions from the nodes 1 and 7, respectively. Meanwhile, the verification unit 25 sets λ (1−(2λ+μ)) to the probability that the state of the storage system 100 still exists at the node 5 at the time 2.

As illustrated in FIG. 15, with respect to, state transitions may occur to the node 7 with the probability μ of recovery from the node 4 (the probability=2λ at the time 1) and the node 5 (the probability=λ at the time 1). The probabilities of the state transitions from the node 4 and the node 5 to the node 7 at the time 2 are calculated by 2λ×μ=2λμ and λ×μ=λμ, respectively, similarly to the above-described calculation. The probability that the state of the storage system 100 still exists at the node 7 at the time 2 is obtained by multiplying the probability (1.0−3λ) of the node 7 at the time 1 by a value which is obtained by subtracting, from 1.0, the probabilities of the state transitions from the node 7 to other nodes. In other words, the probability that the state of the storage system 100 still exists at the node 7 at the time 2 is calculated by (1.0−3λ)×(1.0−3λ)=(1.0−3λ)².

Therefore, as illustrated in FIG. 16, the verification unit 25 sets 2λμ and λμ to the node 7 with respect to the entry of the time 2 as the probabilities of the transitions from the nodes 4 and 5, respectively. Meanwhile, the verification unit 25 sets (1.0−3λ)² as the probability that the state of the storage system 100 still exists at the node 7 at the time 2.

Similarly, the verification unit 25 calculates the probability of each of the nodes with respect to the timing of the time 3 and thereafter, thereby setting the calculated results to the verification table.

As described above, the verification unit 25 calculates the probability that the plurality of storage devices 400 are in a state of the combination of failures indicated by each node for every certain period of time, thereby generating (updating) the verification table. Accordingly, it is possible to calculate the probability of each of the nodes after the elapse of a predetermined period of time (for example, one year) for which the verification of the reliability is intended to be performed.

When the predetermined period of time is reached by accumulation of the certain period of time, the verification unit 25 sums up the probabilities of the nodes excluding the probabilities of the unrestorable nodes. The summed probability is a probability that there is no occurrence of unrestorable failure (being in operation continuously) in the storages after the elapse of the predetermined period of time, and the summed probability may be considered to be a value expressing the reliability of the storage system. In the example illustrated in FIG. 16, the verification unit 25 calculates probabilities Pa, Pb, Pe, Pf, and Ph of the respective nodes after one year, respectively. The verification unit 25 sums up the probabilities excluding the probability Pa of the unrestorable node 0, thereby calculating Pb+Pe+Pf+Ph as a value expressing the reliability of the storage system.

After the reliability of the storage system is calculated, the verification unit 25 stores the calculated results in the retention unit 21 as the verification result 21d. At this time, the verification unit 25 may include the verification table used in the above-described verification in the verification result 21d.

As described above, the verification unit 25 is an example of a calculation unit which calculates information related to the reliability of the storage system 100 on the basis of the simplified model information 21c obtained after two or more first nodes are integrated.

As described above, the client apparatus 201 as the reliability verification apparatus according to the embodiment may shorten the computation time of calculating the reliability of the storage system by simplifying (compressing) a Markov model of the storage system 100 in which a non-MDS code is applied.

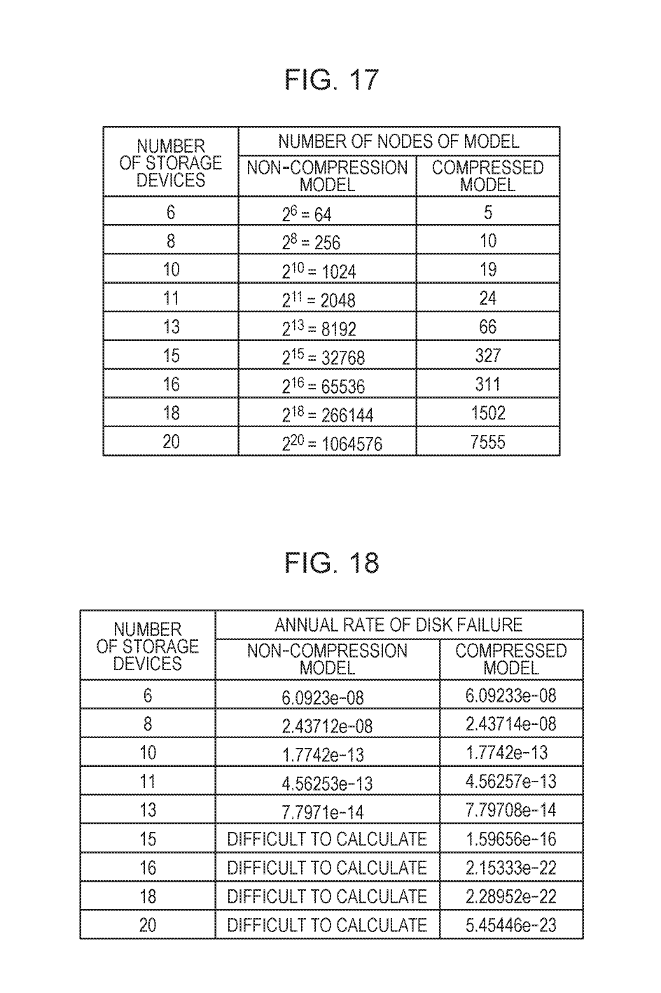

FIG. 17 illustrates an example of a relationship between the number of storage devices and the number of nodes with or without simplification of a Markov model of a storage system in which a non-MDS code is applied.

As illustrated in FIG. 17, when the Markov model is not compressed, the number of nodes exponentially increases relative to the number of storage devices. When the Markov model is compressed by the method according to the embodiment, the rate of increase of the number of nodes is significantly reduced compared to the case of Markov model without compression, and thus, the scale of the model may be suppressed to be small even in a case where the number of storage devices increases.

For example, when the number of storage devices is 13, the number of nodes is 8,192 in the Markov model without compression. In contrast, the number of nodes becomes 66 in the Markov model with compression. This number is comparable with 64 of the number of nodes in the Markov model without compression in a case where the number of storage devices is 6. In this manner, the client apparatus 201 may easily verify the reliability with respect to a Markov model having approximately twice the number of storage devices compared to the case of a Markov model without compression, by compressing the Markov model with the method according to the embodiment.

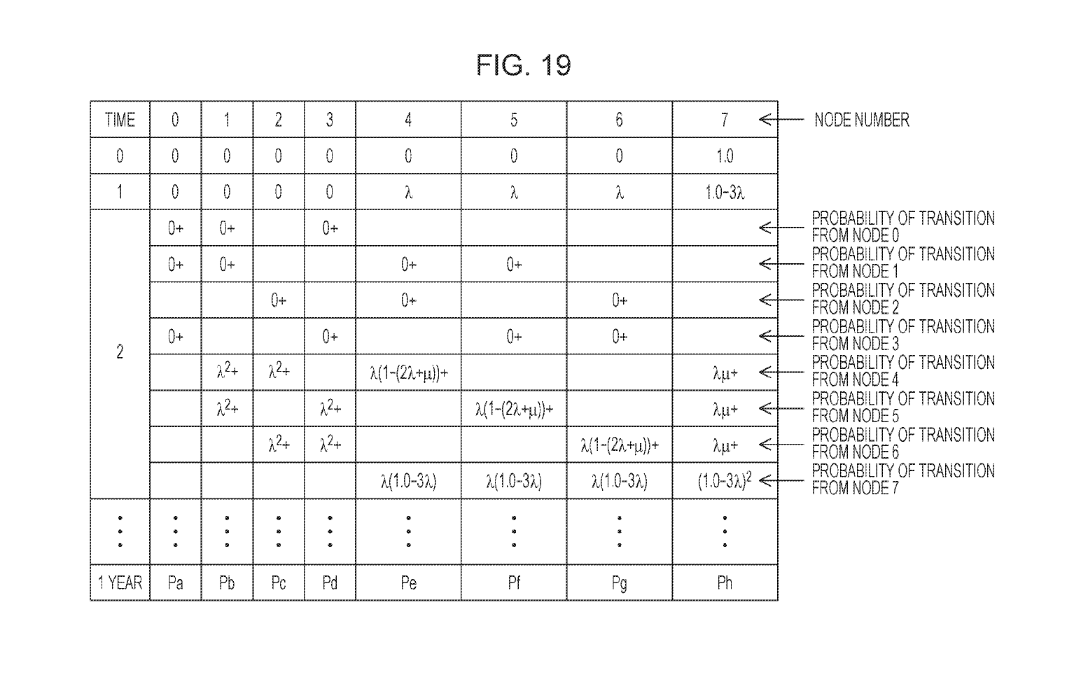

FIG. 19 illustrates a verification table in a case of performing verification by using a Markov model without compression, as a comparison example with respect to the verification table (FIG. 16) in a case where the Markov model is compressed. As is clear from the comparison between the verification tables illustrated in FIGS. 16 and 19, since the number of nodes and the number of edges differ depending on the presence or absence of compression, an amount of computation differs approximately twice at the timing of the time 2 which is close to the initial state. Obviously, the reduction of the number of nodes by compressing a Markov model significantly contributes to shortening the computation time.

As illustrated in FIG. 18, when a Markov model is compressed, compared to a case of a Markov model without compression, the calculated error in an annual rate of disk failure is far below 1%. Obviously, a practically sufficient result may be achieved even though the reliability is verified on the basis of the Markov model with compression.

According to the table illustrated in FIG. 18, when the number of storage devices is equal to or more than 15, it is difficult to calculate the annual rate of disk failure for the Markov model without compression. It is because when the number of storage devices is equal to or more than 15, the number of nodes exceeds 30,000 as illustrated in FIG. 17 so that it takes a great deal of time for processing of computing the annual rate of disk failure.

In contrast, when the Markov model is compressed, it is possible to calculate the annual rate of disk failure even in a case where the number of storage devices is 20. Therefore, it is possible to derive an approximate solution of the reliability of a storage system in which a non-MDS code is applied by compressing the Markov model with the method according to the embodiment even when the storage system has such a scale or greater that the reliability is unlikely to be computed in a case of a Markov model without compression.

In this manner, the client apparatus 201 according to the embodiment may perform a simulation for calculating the reliability of a storage system by utilizing the similarity of Markov models or the remarkably small probability of the state transition between nodes, and simplifying the Markov model (reducing the scale of the Markov model).

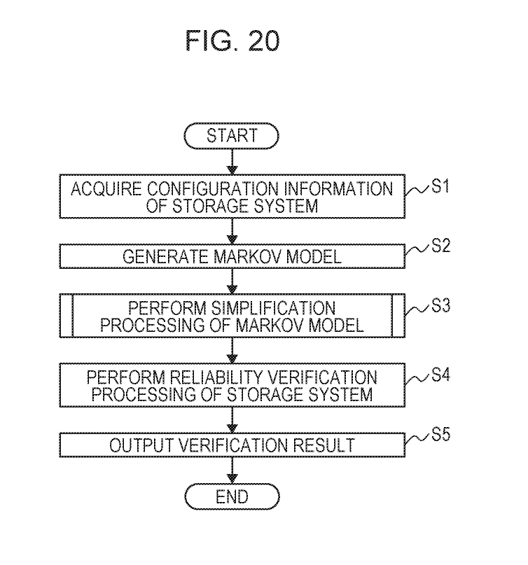

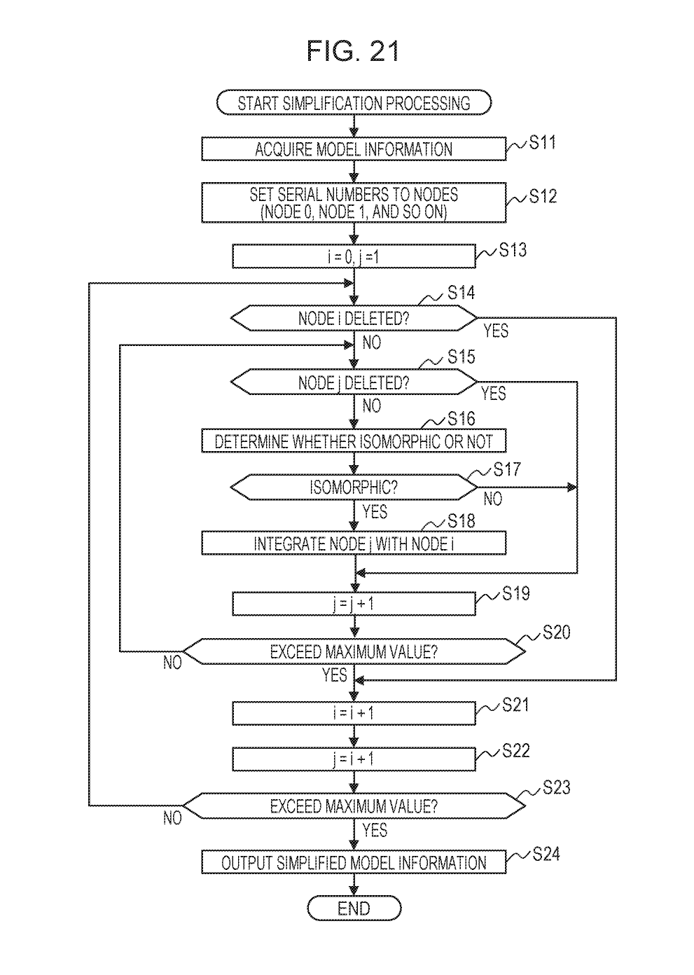

Subsequently, description will be given regarding an exemplary operation of the client apparatus 201 as the reliability verification apparatus according to the embodiment, with reference to FIGS. 20 and 21.

To begin with, with reference to FIG. 20, description will be given regarding the overall processing performed by the client apparatus 201 as the reliability verification apparatus.

First, the information acquisition unit 22 of the client apparatus 201 acquires the configuration information 21a of the storage system 100, thereby storing the acquired configuration information 21a in the retention unit 21 (S1). The model generation unit 23 generates a Markov model (refer to FIGS. 3 and 4) on the basis of the configuration information 21a stored in the retention unit 21, thereby storing the generated Markov model in the retention unit 21 as the model information 21b (S2).

Subsequently, the simplification unit 24 performs simplification processing of the Markov model using the simplification algorithm with respect to the model information 21b stored in the retention unit 21, thereby storing the simplified model information 21c simplified through the simplification processing, in the retention unit 21 (S3). The verification unit 25 performs verification processing of the reliability of the storage system on the basis of the simplified model information 21c stored in the retention unit 21, thereby storing the verification result obtained through the verification processing in the retention unit 21 as the verification result 21d (S4).

Ultimately, the result output unit 26 outputs the verification result 21d stored in the retention unit 21, to an operator (S5), thereby ending the processing.

Next, with reference to FIG. 21, description will be given regarding the simplification processing of the Markov model obtained by the client apparatus 201 as the reliability verification apparatus. The example illustrated in FIGS. 3 and 4 is taken as the model information 21b (the Markov model) on the premise.

First, the simplification unit 24 acquires (refers to) the model information 21b stored in the retention unit 21 (S11), thereby setting serial numbers (node numbers) to the nodes in order starting from the node having the most failed storage devices 400 (S12). For example, the node numbers are set in a manner of the node 0, the node 1, and so on to the node 7 (refer to FIGS. 7 and 8). The simplification unit 24 defines i=0 and j=1 as variables for selecting two nodes (selected nodes) (S13).

Subsequently, the simplification unit 24 determines whether or not a node i has been deleted with reference to the table of the Markov model (S14). When the node i has not been deleted (No in S14), the simplification unit 24 determines whether or not a node j has been deleted (S15). When the node j has not been deleted (No in S15), the simplification unit 24 determines whether or not the child graph of the node i and the child graph of the node j are isomorphic to each other (S16).

When the child graph of the node i and the child graph of the node j are isomorphic to each other (Yes in S17), the simplification unit 24 reconnects all the edges for transition to the node j, to the node i in the Markov model table. The simplification unit 24 deletes, in the table, the node j and the edges for transitions from the node j (S18).

The simplification unit 24 adds (increments) 1 to the variable j (S19), thereby determining whether or not the variable j exceeds the maximum value (in this case, 7) of the serial numbers (the node numbers) (S20). When the variable j does not exceed the maximum value of the serial numbers (No in S20), the processing proceeds to S15. When the variable j exceeds the maximum value of the serial numbers (Yes in S20), the processing proceeds to S21.

When the node j has been deleted in S15 (Yes in S15), or when the child graph of the node i and the child graph of the node j are not isomorphic to each other in S17 (No in S17), the processing proceeds to S19. When the node i has been deleted in S14 (Yes in S14), the processing proceeds to S21.

In S21, the simplification unit 24 adds (increments) 1 to the variable i. Subsequently, the simplification unit 24 sets a value obtained by adding 1 to i to which 1 is added in S21, to the variable j (S22).

The simplification unit 24 determines whether or not the variable j exceeds the maximum value (in this case, 7) of the serial numbers through the processing of S21 and S22 (S23). When the variable j does not exceed the maximum value of the serial numbers (No in S23), the processing proceeds to S14. When the variable j exceeds the maximum value of the serial numbers (Yes in S23), the simplification unit 24 outputs (stores) the table which is generated (modified) in S18 to the retention unit 21, for example, as the simplified model information 21c (S24), thereby ending the processing.

In accordance with the above-described processing, the simplification unit 24 may select two nodes (the selected nodes) in all of the combinations of the nodes in order starting from the node having a lower number. Then, the simplification unit 24 determines whether or not the child graphs of the two selected nodes are isomorphic to each other. When the two selected nodes are isomorphic to each other, a child graph of the node having a higher node number may be integrated with the other child graph.

As illustrated in FIG. 22, the above-described client apparatus 201 according to the embodiment may include a central processing unit (CPU) 201a, a memory 201b, a storage unit 201c, the interface unit 201d, the I/O unit 201e, and the reading unit 201f.

The CPU 201a is an example of an arithmetic processing unit (a processor) which performs various types of controlling and computing. The CPU 201a is connected to each of corresponding blocks 201b to 201f. The CPU 201a executes a program which is stored in the memory 201b, the storage unit 201c, a recording medium 201g, a read-only memory (ROM) (not illustrated) or the like to realize various types of functions.

The memory 201b is a storage device which stores therein various types of data and programs. The CPU 201a stores the data and the program in the memory 201b and performs an operation when executing the program. As the memory 201b, for example, a volatile memory such as a random access memory (RAM) may be exemplified.

The storage unit 201c is hardware which stores therein various types of data, programs, and the like. As the storage unit 201c, various types of devices, for example, a magnetic disk device such as an HDD, a semiconductor drive device such as an SSD, and a non-volatile memory such as a flash memory and a ROM may be exemplified. The retention unit 21 illustrated in FIG. 2 may be realized by the memory 201b or the storage unit 201c.

For example, the storage unit 201c may store therein a reliability verification program 200 for realizing all or a portion of various types of functions of the client apparatus 201 as the reliability verification apparatus.

The interface unit 201d is a communication interface which controls a wired or wireless connection and communication with the network 500, other information processing apparatuses, or the like. As the interface unit 201d, an adaptor conforming to various types of interfaces, for example, a LAN, a SAN, a fibre channel (FC), and InfiniBand may be exemplified. For example, the CPU 201a may store the reliability verification program 200 obtained via the interface unit 201d and the network 500 in the storage unit 201c.

The I/O unit 201e may include at least one of an input device (operation unit) such as a mouse, a keyboard, a touch panel, and a microphone for a voice operation, and an output device (output unit, display unit) such as a display, a speaker, and a printer. For example, the input device may be used by an operator when working on various types of operations of the client apparatus 201 and inputting data such as the configuration information 21a (or the model information 21b). The output device may be used when outputting (displaying) the verification result 21d or various types of notification.

The reading unit 201f is a device which reads data or a program recorded in a computer-readable recording medium 201g. The reliability verification program 200 may be stored in the recording medium 201g.

For example, the CPU 201a may realize the function of the client apparatus 201 as the reliability verification apparatus, by loading the reliability verification program 200 stored in the storage unit 201c or the recording medium 201g to a storage device such as the memory 201b and executing the reliability verification program 200.

As the recording medium 201g, for example, a flexible disk, a compact disk (CD), a digital versatile disc (DVD), an optical disc such as a blu-ray disc, a universal serial bus (USB) memory, and a flash memory such as a secure digital (SD) card may be exemplified. As the CD, a CD-ROM, a CD recordable (CD-R), a CD rewritable (CD-RW), and the like may be exemplified. As the DVD, a DVD-ROM, a DVD-RAM, a DVD-R, a DVD-RW, a DVD+R, a DVD+RW, and the like may be exemplified.

The above-described blocks 201a to 201f are communicably connected to each other via a bus. The above-described hardware configuration of the client apparatus 201 is an example. Therefore, an increase or a decrease of the hardware (for example, arbitrarily performed addition or omission of a block), division, integration into an arbitrary combination, addition or omission of a bus, and the like may be suitably performed in the client apparatus 201.

Hereinbefore, the embodiment is described in detail. However, the embodiment is not limited to a particular embodiment. The embodiment may be subjected to various changes and modifications and executed without departing from the scope of the gist of the embodiment.

For example, each of functional blocks of the client apparatus 201 illustrated in FIG. 2 may be unified in an arbitrary combination or divided.

In the above-described description, the node numbers are set in order starting from the node having most failed storage devices 400. However, the embodiment is not limited thereto, and the sequence may be differently formed. Moreover, as long as the sequence of nodes may be decided among the plurality of nodes, an arbitrary character string may be used instead of the node numbers.

Moreover, the functions of the verification unit 25 and the result output unit 26 may be omitted in the client apparatus 201. In this case, the client apparatus 201 may be positioned as an optimization apparatus for models (or a model analysis apparatus) which simplifies a Markov model of the model information 21b so as to reduce the scale thereof, and generates optimized simplified model information 21c. In this case, the client apparatus 201 favorably outputs optimized simplified model information 21c to other verification apparatuses having functions of the verification unit 25 and the result output unit 26 (for example, a reliability verification apparatus).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium having stored therein a program that causes a computer to execute a process, the process comprising:
acquiring a transition model indicating state transitions between a plurality of nodes, each of the plurality of nodes indicating a combination of presence or absence of a failure of each of a plurality of redundant storage devices included in a storage system, different nodes of the plurality of nodes indicating different combinations of presence or absence a failure of each of the plurality of redundant storage devices;
selecting, from the plurality of nodes, a plurality of first nodes different from each other on basis of the transition model;
extracting sub-models for the respective first nodes on basis of the transition model, the sub-models indicating state transitions occurring due to a failure of any of the plurality of redundant storage devices from the respective first nodes;
modifying the transition model such that two or more first nodes are integrated into one first node of the two or more first nodes when the sub-models extracted for the two or more first nodes satisfy a predetermined condition; and
calculating reliability information regarding reliability of the storage system on basis of the modified transition model.

2. The computer-readable recording medium according to claim 1, the process further comprising:
performing the selection, the extraction, and the modification, for each combination of the plurality of first nodes while selecting the plurality of first nodes in order starting from a node indicating a combination of presence or absence of a failure for most failed storage devices.

3. The computer-readable recording medium according to claim 1, the process further comprising:
performing the modification by causing first state transitions to be headed for the one first node and deleting the two or more first nodes other than the one first node, the first state transitions being headed any for the two or more first nodes other than the one first node, the first state transitions occurring due to a failure of any of the plurality of redundant storage devices.

4. The computer-readable recording medium according to claim 3, wherein
the one first node is a node indicating a combination of presence or absence of a failure for most failed storage devices among the two or more first nodes.

5. The computer-readable recording medium according to claim 1, wherein
each of the sub-models indicates state transitions in a node group including corresponding one of the plurality of first nodes and one or more second nodes each of which is reached by repeating state transitions occurring due to a failure of any of the plurality of redundant storage devices from the one of the plurality of first nodes, and
the process further comprises:
comparing a first sub-model with a second sub-model, the first sub-model indicating state transitions in a first node group, the second sub-model indicating state transitions in a second node group different from the first node group; and
determining that the first sub-model and the second sub-model satisfy the predetermined condition when the first sub-model and the second sub-model are determined to be isomorphic to each other.

6. A reliability verification apparatus, comprising:
a memory device configured to
store therein a transition model indicating state transitions between a plurality of nodes, each of the plurality of nodes indicating presence or absence of a failure of each of a plurality of redundant storage devices included in a storage system, different nodes of the plurality of nodes indicating different combinations of presence or absence of a failure of each of the plurality of redundant storage devices; and
a processor configured to
select, from the plurality of nodes, a plurality of first nodes different from each other on basis of the transition model stored in the memory device,
extract sub-models for the respective first nodes on basis of the transition model, the sub-models indicating state transitions occurring due to a failure of any of the plurality of redundant storage devices from the respective first nodes,
modify the transition model such that two or more first nodes are integrated into one first node of the two or more first nodes when the sub-models extracted for the two or more first nodes satisfy a predetermined condition, and
calculate reliability information regarding reliability of the storage system on basis of the modified transition model.

7. A storage system, comprising:
a plurality of redundant storage devices; and
a reliability verification apparatus including:
a memory device configured to
store therein a transition model indicating state transitions between a plurality of nodes, each of the plurality of nodes indicating presence or absence of a failure of each of the plurality of redundant storage devices, different nodes of the plurality of nodes indicating different combinations of presence or absence of a failure of each of the plurality of redundant storage devices, and
a processor configured to
select, from the plurality of nodes, a plurality of first nodes different from each other on basis of the transition model stored in the memory device,
extract sub-models for the respective first nodes on basis of the transition model, the sub-models indicating state transitions occurring due to a failure of any of the plurality of redundant storage devices from the respective first nodes,
modify the transition model such that two or more first nodes are integrated into one first node of the two or more first nodes when the sub-models extracted for the two or more first nodes satisfy a predetermined condition, and
calculate reliability information regarding reliability of the storage system on basis of the modified transition model.
